(19) United States
(12) Patent Application Publication
(10) Pub. No.: US 2015/0033622 A1
(43) Pub. Date: Feb. 5, 2015

(54) REFLECTIVE GROUND COVER MATERIAL

(71) Applicant: Jonathan Dallas Toye, Rosedale (NZ)

(72) Inventor: Jonathan Dallas Toye, Rosedale (NZ)

(73) Assignee: Extenday IP Limited, Rosedale (NZ)

(21) Appl. No.: 14/005,218

(22) PCT Filed: Mar. 16, 2012
(86) PCT No.: PCT/NZ2012/000040

§ 371 Date: Nov. 18, 2013

(30) Foreign Application Priority Data
Mar. 16, 2011 (NZ) 591758
Mar. 23, 2011 (NZ) 591889

(51) Int. Cl. A01G 13/00

(52) U.S. Cl. CPC A01G 13/0256
USPC 47/20.1

(57) ABSTRACT

A reflective ground cover sheet material for agricultural use woven from warp and weft tapes of a plastics film material has an average gap g between edges of adjacent tapes in both the warp and the weft direction in the range about 0.1 mm to about 1.2 mm. The tapes may be of width w in the range 2 to 7 mm. The materials may optimise air, water, solar transmission, long wave radiation or heat and dirt/soil movement through the material, and sufficient coverage and reflectivity, and physical material construction strength.

### FIELD OF THE INVENTION

The invention relates to reflective woven ground cover materials.

### BACKGROUND TO THE INVENTION

Woven ground cover materials are used in agriculture for a number of purposes including weed suppression and/or soil warmth retention and/or moisture retention and/or for light reflecting.

Typically where a material is used primarily as a reflective ground cover for light enhancement, the material is rolled out in lengths onto the ground, and secured in place, beneath or between rows of trees, vines, or plants, to increase the amount of light to which the plants and in particular fruit are exposed by reflection of light from the material towards the fruit above. The material may also aid soil warmth retention and moisture retention.

The sheet material will typically remain in place for some months, before being removed and reused in a subsequent growing season or on another crop in the same growing season, but in some cases may remain in place over multiple growing seasons.

The use of such woven ground cover sheets is a relatively new practice in agriculture. Generally the sheet material is woven tightly and provides a complete cover. However such materials can give rise to some horticultural issues:
Over time they may get soil lodged between the tapes from which the materials are woven, which may reduce the reflective and transmission properties of the materials. The reduction in reflectivity reduces their effectiveness as reflective materials. The reduced transmission reduces their ability to warm the soil beneath the cover and restricts the small amount of light transmission needed for the protective of the cover crop beneath the cover. The soil in the tightly woven material also makes the covers heavier to handle.
Excessive moisture retention beneath the material, leading to water saturated soils, anaerobic soil conditions, soil compaction, wheel rutting of the ground surface and similar negative effects on the growing conditions due to high soil moisture.
Excessive restriction on soil heat moving from the soil to the plants above the sheet, due to not allowing sufficient air and heat movement though the material that can bring about excessively cold conditions at night for the plants/crop above the cover due to the restriction of soil heat radiation from the soil to the plant at night. This night time heat movement from the soil to the plant is important to maintain air temperature for plants above the soil and assist in reducing the occurrence of frost conditions.

Woven reflective ground cover materials are disclosed in U.S. Pat. No. 6,339,898 and international patent application publications WO2006/009479 and WO2011/008109.

It is an object of the present invention to provide improved reflective ground cover materials, or to at least provide the public with a useful choice.

### SUMMARY OF THE INVENTION

In broad terms the invention comprises a reflective ground cover sheet material woven from warp and weft tapes of a plastics material wherein the average gap between edges of adjacent tapes in both the warp and the weft direction is in the range about 0.1 mm to about 1.2 mm.

‘Gap’ refers to the substantially in-plane air space between the adjacent tapes when the sheet material is laid out flat.

In some embodiments the warp and weft tapes are of similar width, and the gap area between adjacent tapes is square. This allows the tapes to move apart more easily in either direction, to allow soil lodged between tapes to be removed with least resistance. A square gap area between the tapes may also allow best movement of air, water, or heat though the material, alternatively the gap area may be rectangular.

In some embodiments the average gap between edges of adjacent tapes in both the warp and the weft direction is in the range about 0.2, 0.25, or 0.3 mm to about 0.4, 0.5, 0.6, 0.65, 0.7, 0.8, 0.85, 0.9, 1, or 1.1 mm. The gap area defined between edges of adjacent tapes in the warp and the weft direction may be in the range about 0.02 to 1.3 mm2 or higher, for example.

A preferred tape width is about 4 mm, for a thin film tape therefore having a high ratio of tape width to thickness. Alternatively in other embodiments the tapes may have a width up to about 7 mm wide or down to about 2 mm for example.

The selected tape width and the tape insertion determines the gap or gap area between the tapes. To achieve a desired tape gap, the tape width is known and the tape insertion can then be determined. From the tape width and tape insertion (or density) the coverage factor is calculated as is the overall material area less the total air gap area, or porosity, of the material, for the warp or weft in one direction only.

Materials of the invention may also have:
a porosity in the range about 0.5 to about 2%, and/or
a warp and weft tape width in the range about 1 or 2 to about 7 or up to 10 mm, and/or
an insertion/density/number per inch of warp and weft tapes in the range about 3 to about 12 per inch/25.4 mm, and/or
a cover factor in the range about 85 to about 95%.

In some embodiments the material has a porosity in the range from about 0.5% to about 1.9%, or in the range about 0.5% or 1% to about 0.8%, 1.3% or 1.5% or 1.7% or 1.9%.

In some embodiments the warp and weft tapes have a tape width in the range about 3.5 to about 4.5 mm, about 3.8 to 4.2 mm, or about 4 mm.

In some embodiments the warp and weft tapes have an insertion/density/number per inch in the range about 4 to about 10, or about 5 to about 8, or about 5 to about 7.

A preferred ground cover sheet material of the invention is formed of 4 mm width warp and weft tapes with an insertion of 5.8 tapes per 25.4 mm. More open materials can be formed with insertions of 5.6 or 5.5 tapes per 25.4 mm for (4 mm tapes).

In some embodiments there are more warp tapes in one or more lengthwise extending strip side portions of the material than in a wider lengthwise extending centre strip portion of the material, to strengthen the lengthwise extending side portions of the material. That is, the material comprises a lower porosity/higher density of tapes in lengthwise extending side portions of the material.

In some embodiments the material has a cover factor in the range from about 75 to 85% or 85 to 95%, or about 87 to 89% for the warp or weft direction individually.

The tapes are preferably also woven into the material substantially without lengthwise folding of the tapes. Many woven sheets are made with folded tapes. Tape folding may allow soil or plant debris matter to collect in the tapes and/or the material more easily, and reduce natural soil or debris removal by the action of wind and/or rainfall/irrigation.

Materials of the invention may optimise in allowing the right amount of air, water, solar transmission, long wave radiation or heat and dirt/soil movement through the material, and sufficient coverage and reflectivity, and physical material construction strength with the necessary handling and durability properties needed by the user. Ground cover sheet materials of the invention may allow an optimum balance between being an effective reflective cover and also allowing good movement of air, water, solar radiation and thermal soil heat radiation though the cover to give the optimum growing conditions above and below the sheet.

The term “density” as used in this specification, unless the context suggests otherwise, is intended to mean the number of weft or warp tapes woven to form the material per unit area, such as per 25.4 mm² (inch²), or alternatively the average number across the width of material of weft or warp tapes woven to form the material per unit length, such as per 25.4 mm (inch). The term “insertion/inch” has a similar meaning.

The term “porosity” is intended to mean the area of the holes or apertures directly through the material perpendicular to the plane of the material (and excluding lateral apertures through the material not apparent when the material is viewed from a direction perpendicular to the plane of the material) between the warp and weft tapes of the material relative to the whole surface area of the material, expressed as a percentage. For example, a material having warp and weft tapes spaced apart from each other so that the air space between the warp and weft tapes constitutes 1.5% per square meter surface area of the material will have a porosity of 1.5%. The porosity is made up of small (less than 2 mm per edge) evenly spaced apertures rather than large (greater than 2 mm per edge) holes.

By “cover factor” is meant the percentage of the overall area of the material which comprises knitted, woven, or non-woven monofilament, yarn, or tape or a combination, forming the material itself judged from perpendicular to the plane of the netting when laid out flat, as opposed to air space in between the material.

By “reflective” in general is meant that the material is reflective of at least 30% on average of visible light or of energy across any particular wavelength range of interest, more preferably at least 40%, 50% or 60% or 70% or 80% or 90%, on at least one side of the netting material. At some wavelengths within the particular wavelength range of interest the material may be less reflective, so long as the average of the reflectance of the material at all wavelengths across the wavelength range of interest is at least the minimum specified.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

### BRIEF DESCRIPTION OF THE DRAWINGS

Preferred embodiments of the invention will be further described by way of example only and with reference to the accompanying drawings, in which:

FIG. 1 is a schematic plan view of a section of ground cover material of the invention, woven with warp and weft tapes;

FIG. 1a-e are schematic close up plan views of a smaller sections of ground cover material of the invention, of different levels of gap or openness;

FIG. 2 is a perspective view of the woven ground cover material of the invention fixed between two rows of trees;

FIGS. 2a, 2b and 2c schematically illustrate movement of moisture, air, and heat through a section of material of the invention; and

FIG. 3 is a schematic perspective view showing the typical defining dimensions of a rectangular cross-section warp or weft tape used to weave the ground cover material of the invention.

### DETAILED DESCRIPTION OF PREFERRED EMBODIMENTS

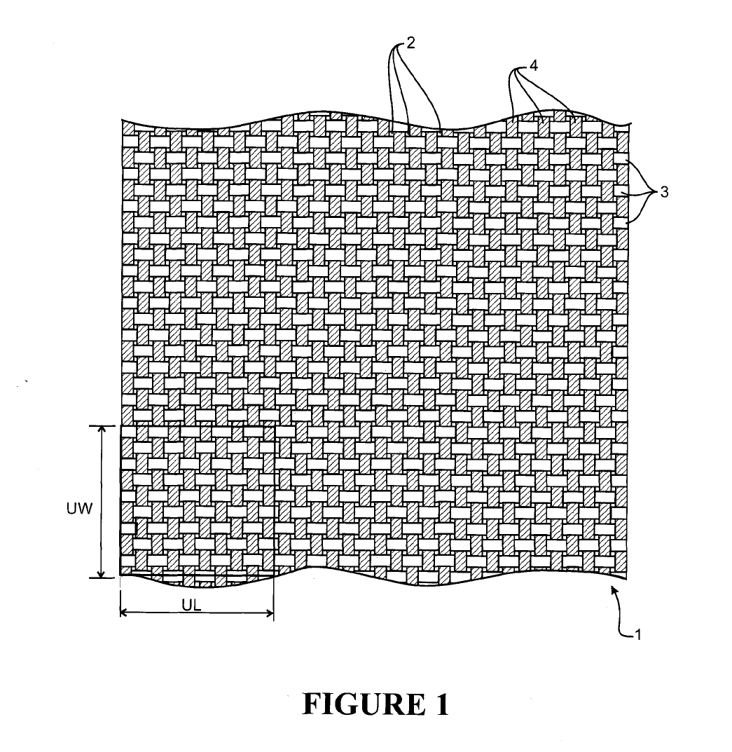

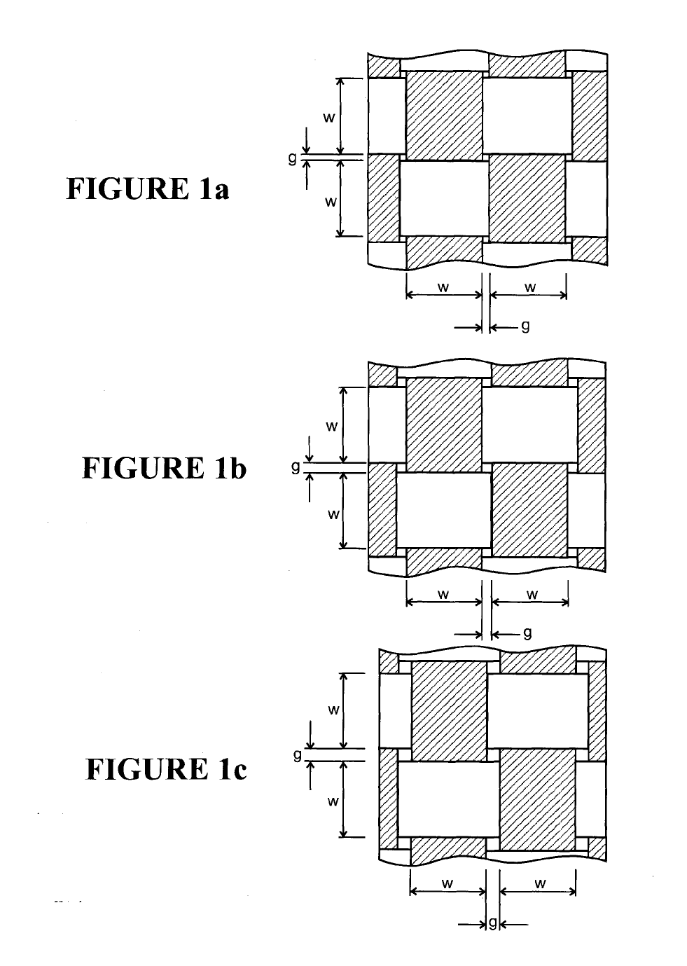

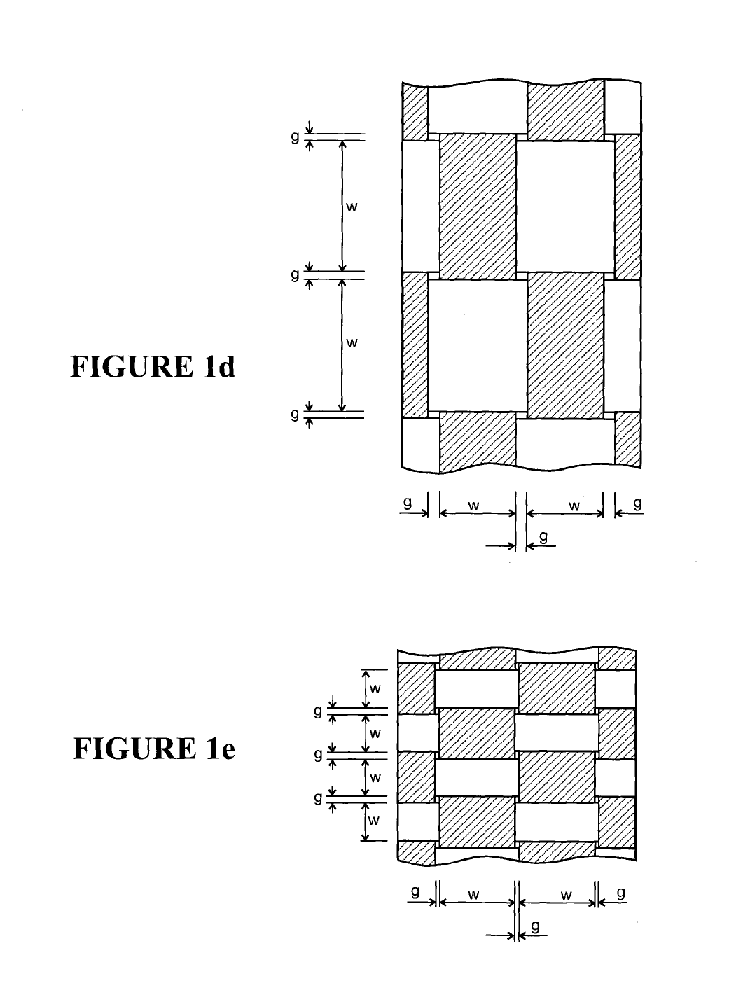

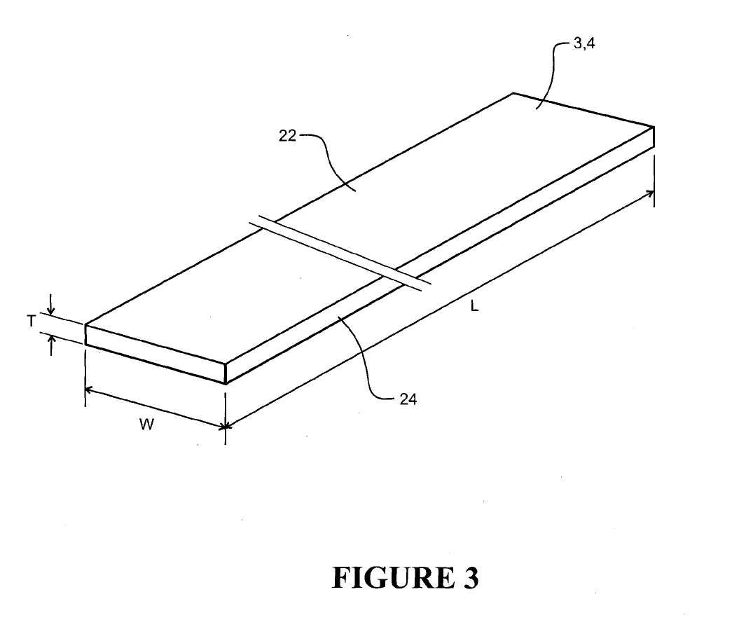

FIG. 1 shows a section of ground cover material or sheeting 1. The material 1 is woven from flat warp 3 and weft 4 tapes of a plastics material while 2 indicates the gaps or gap areas between edges of adjacent tapes which gives the fabric its openness as defined above. The tapes may be formed by extruding a film material from a polymer resin and then cutting the film into tapes which are in turn used to weave the material, or by extruding individual tapes. The tapes have width W many times such as 10 or 20 or 50 times greater than thickness T (see FIG. 3). The material is woven preferably without lengthwise folding of the tapes.

FIG. 1a-e show smaller sections of ground cover material of five levels of openness and dimensions of gaps and gap areas. In the embodiments of FIGS. 1a-c the warp and weft tapes are of width w about 4 mm and the gap areas 2 defined between adjacent tapes are square. In the embodiment of FIG. 1a the average gap g between edges of adjacent tapes in both the warp and the weft direction is about 0.35 mm. In the embodiment of FIG. 1b the average gap g is about 0.5 mm. In the embodiment of FIG. 1c the average gap g is about 0.65 mm. In the embodiments of FIGS. 1d and 1e the material is woven from warp and weft tapes of different widths, which are 4 mm and 7 mm in the embodiment of FIG. 1d and 4 mm and 2 mm in the embodiment of FIG. 1e. The gap areas 2 have dimensions of about 0.6×0.35 in the embodiment of FIG. 1d and 0.2×0.35 in the embodiment of FIG. 1e.

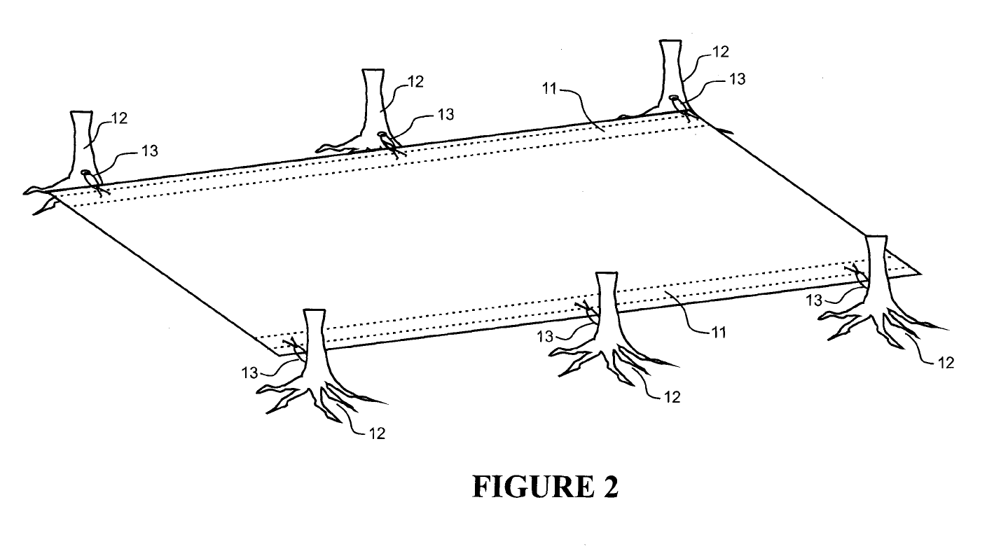

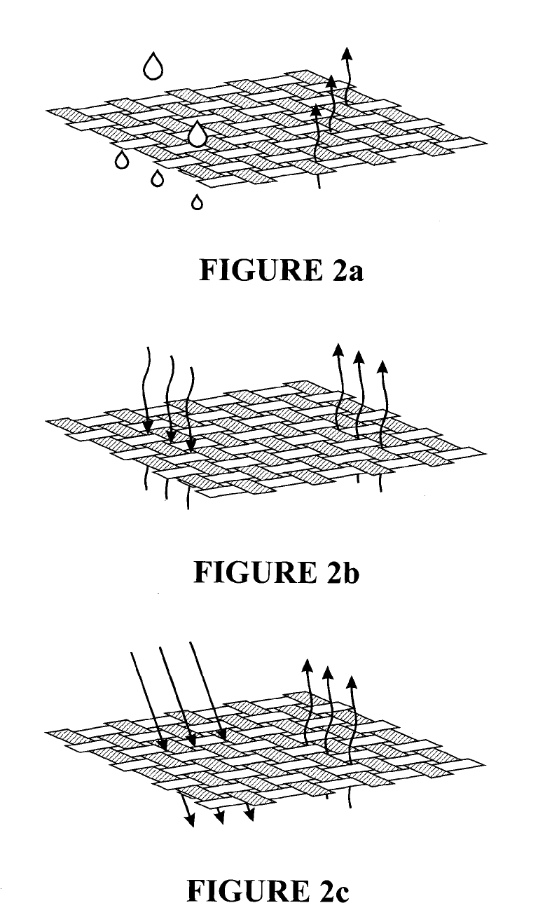

Typically the material has a greater length than width and is provided as a roll or in concertina folded form and lengths of the ground cover material are placed between or beneath rows of crops, for example fruit trees, in various ways, depending on the primary function of the ground cover material, for example factors like weed suppression, moisture retention and/or light reflectivity, and the type of surface profile of the ground soil underneath the material. Some of the various options and configurations will be described by way of example only. FIG. 2 shows the ground cover material 10 positioned over the ground between and beneath rows of orchard trees 12. To anchor the material in place, optionally fastening claws 13 connect to the sheeting along its edges 11, and in turn may connect by loops or lengths of extensible or optionally inextensible material to staples inserted into the spaced trees as shown, or alternatively to stakes or pegs hammered into the ground, or to a wire extending along the row of the trees or vines, for example. The material may be anchored on or close to the ground, where the material is weed matting for example and is needed to hold in more soil moisture, or over but higher above the ground where the material is a reflective material provided to reflect solar radiation onto the fruit trees and fruit from below.

FIGS. 2a, 2b and 2c show how the fabric is a membrane allowing the movement of rainfall or irrigation though the material to the soil below it and then water vapour from the soil and the cover crop (mostly grasses) moving from beneath the material to above the material—FIG. 2a. In FIG. 2b the movement of air is also shown, which allows the exchange of gases between the air above and below the material, it also carries the water vapour and heat both ways though the material. Some solar radiation is reflected by the material and some is transmitted through the material to the ground beneath the material, and then soil heat radiation going from the soil to the air above the material—FIG. 2c.

FIG. 3 is a schematic perspective view showing the typical defining dimensions of a rectangular cross-section warp or weft tape used to weave the ground cover material of the invention. The warp and/or weft tapes have an indefinite length, designated by reference double-ended arrow L. The top and bottom surfaces 22 and 24 of the tape form the top and bottom surfaces of the ground cover material once woven. The tapes are substantially rectangular in cross-section and have a width W, which is substantially uniform along the length of the tape.

In accordance with the invention the average gap between edges of adjacent tapes in both the warp and the weft direction is in the range about 0.1 mm to about 1.2 mm. In some embodiments the average gap between edges of adjacent tapes in both the warp and the weft direction is in the range about 0.2 or 0.3 mm to about 0.4, 0.5, 0.6, 0.7, 0.8, 0.9, 1, or 1.1 mm. The average gap area defined between edges of adjacent tapes in the warp and the weft direction may be from 0.02 mm2 to 1.3 mm² or higher, for example. For 4 mm tapes both warp and weft the gap area is from 0.09 to 0.42 mm2. The total gap area is about 0.5 to 2.0%, or 0.005 m2 to 0.02 m² per m2 of fabric.

In some embodiments the average gap between edges of adjacent tapes in both the warp and the weft direction is in the range about 0.3 mm to about 0.4 mm. In some embodiments the average gap between edges of adjacent tapes in the warp direction is about 0.4 mm and in the weft direction is also about 0.4 mm. In other embodiments however the average gap between edges of adjacent tapes in the warp or the weft direction may be about 0.8 mm and in the weft or the warp direction may be about 0.2 mm, or vice versa, for example. In both of these and other cases the in plane area of the warp-weft gap between two adjacent warp tapes and two adjacent weft tapes is about 0.16 mm². In other embodiments the area may be in the range about 0.09 to about 0.25 mm², or about 0.36 to about 0.49 mm².

If the warp and weft tapes are not the same width then the area between edges of adjacent tapes will not be square. This will affect the gap distance needed to achieve the right level of porosity for the fabric. Nevertheless by varying the gap distance the right level of openness can be achieved.

The material may also have:
a porosity in the range about 0.5 to about 2%, and/or
a warp and weft tape width in the range 1 or 2 to 10 or 7 mm, and/or
a warp and weft tape insertion per inch in the range 3 to 12 per inch/25.4 mm, and/or
a cover factor in the range 75% or 85 to 95% for the warp or weft directions.

In some embodiments the material has a porosity in the range from about 0.5% to about 1.9, or in the range about 0.5 or 1% to about 0.8%, 1.3%, 1.5%, or 1.7%, or in the range from greater than 1% to 1.5 or 1.7 or 1.9%.

In some embodiments the warp and weft tapes have a tape width in the range about 3.5 to about 4.5 mm, or about 4 mm.

In some embodiments the warp and weft tapes have an insertion per inch in the range 4 to 7 or about 5.8 per inch.

In some embodiments the material has a cover factor in the range from about 75 to 85%, or 85 to 95%, or about 90 to 95% in one direction, the warp or weft direction.

Particularly preferred embodiments of reflective ground cover sheet materials of the invention are as follows based on a square construction, the warp and weft tapes are the same width:

Product with First Level of Openness, Stage One:
Gap between edges of adjacent tapes in warp direction 0.35 mm
Gap between edges of adjacent tapes in weft direction 0.35 mm
Warp tape width 4 mm
Weft tape width 4 mm
Insertion per inch, 25.4 mm: Warp 5.8 to 5.9, Weft 5.8 to 5.9
   Product with More Open Weave, Stage Two, for Higher Levels of Conductivity:
Gap between edges of adjacent tapes in warp direction 0.5 mm
Gap between edges of adjacent tapes in weft direction 0.5 mm
Warp tape width 4 mm
Weft tape width 4 mm
Insertion per inch, 25.4 mm: Warp 5.6 to 5.7, Weft 5.6 to 5.7
   Product with More Open Weave, Stage Three for Even Higher Levels of Conductivity:
Gap between edges of adjacent tapes in warp direction 0.65 mm
Gap between edges of adjacent tapes in weft direction 0.65 mm
Warp tape width 4 mm
Weft tape width 4 mm
Insertion per inch, 25.4 mm: Warp 5.4 to 5.5, Weft 5.4 to 5.5

The tables in the appendix give information for a number of specific embodiments of the invention, for different warp and weft tape widths.

In some embodiments there are more and/or thicker warp tapes in one or more lengthwise extending strip side portions of the material than in a wider lengthwise extending centre strip portion of the material, to strengthen the lengthwise extending side portions of the material. That is, the material comprises a lower porosity/higher density/heavier area of tapes in lengthwise extending side portions of the material.

The fabric openness is focused on the central part of the fabric away from the edges of the fabric sheet.

The tapes may be formed from any suitable polyolefin such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA) and ethylene methyl acrylate (EMA) are useful for imparting elasticity and other properties. Polyesters and polystyrene, styrene-butdienie (SB), acrylonitrile-butadienie-styrene (ABS), styrene-aciylonitrile (SAN), polyethylenie terephithialate (PEI), polymethylmethacrylate (PMMA) and polycarbonate are useful as dye carriers and also for influencing radiation (reflecting, absorbing and transmission) properties and also other properties on the materials. Starch and other plant polymers are useful to increase biodegradability. Alternatively the tapes may comprise in part or whole of paper, wood or cellulose fibre, starch based polymers, casein, latex or in any combination of the above and/or with petroleum derived plastic polymers. The polymer or polymer blend may incorporate agents such as one or more pigments, UV stabilisers, or processing aids.

The material is reflective of at least 30% or alternatively at least 40% or even 50% or alternatively at least 55% or alternatively at least 60% of visible light on at least one side of the material. In one embodiment of a reflective material the material may reflect at least 40% solar radiation on average across the UV (wavelength about 280-400 nm), visible (wavelength about 400-700 nm) and very near infrared (wavelength about 700-800 nm) ranges, and which transmits at least 10% or 5% on average of solar radiation across the wavelength range about 800-2500 nm. The material may reflect more solar radiation than it transmits and absorbs in the UV, visible, and very near infrared ranges. The material may transmit at least 15% or at least 20% of solar radiation on average in the wavelength range about 800-2500 nm. Some or all tapes of a reflective material may be formed from a resin comprising a white pigment, which resin has been formed by mixing a masterbatch consisting essentially of 5 to 90% by weight of a white pigment or combination of pigments chosen from zirconium, strontium, barium, magnesium, zinc and calcium pigments, and a first polymer, with a second polymer such that the resin (masterbatch) comprising the white pigment comprises between about 1 to 50% by weight of the total mixture. In certain embodiments the white pigment may be selected from titanium dioxide, zirconium, dioxide, magnesium, zirconate, calcium zirconate, strontium zirconate, barium zirconate, zirconium silicate, zinc sulphide, calcium carbonate, barium sulphate, magnesium oxide, strontium carbonate, barium carbonate, and potassium titanate.

In some embodiments the material may incorporate a compound or compounds added to cause or increase the extent to which the material reflects and/or absorption of radiation from the earth (terrestrial (long wave or infrared) radiation). Thus when the material is placed over or adjunct to plants it will assist in retaining heat beneath the material, which may be desirable for some plants or applications.

In some embodiments the material may incorporate a compound or compounds added to cause or increase the extent to which the material allows transmission and/or absorption of radiation from the earth (terrestrial (long wave or infrared) radiation). Thus when the material is placed over or adjacent to plants it will assist in releasing the heat beneath the material, which may be desirable for some plants or applications.

In other embodiments the material may incorporate a compound or compounds added to cause or increase the extent to which the material reflects and/or absorbs solar radiation. Thus when the material is placed over or adjunct to plants it will assist in cooling beneath the material, which may be desirable for some plants or applications.

In other embodiments the material may incorporate a compound or compounds added to cause or increase the extent to which the material allows transmission and/or absorption of solar radiation. Thus when the material is placed over or adjunct to plants it will assist in increasing the heat beneath the material, which may be desirable for some plants or applications.

Typically reflective sheet materials of the invention will be laid out in lengths on the ground between or beneath rows of the crop being grown, which may be trees, vines, bushes etc, and the materials are referred to in the specification as “ground cover sheet materials”. It is possible however that the materials may be suspended or positioned above the ground in a vertical or angled position to reflect the solar radiation onto the crop, for example on either side of the crop row, for example trees, and the expression “ground cover sheet material” is intended to encompass materials for such applications also.

The foregoing describes the invention including preferred forms thereof. Alterations and modifications as will be obvious to those skilled in the art are intended to be incorporated in the scope hereof as defined in the accompanying claims.

APPENDIX
Square Warp and Weft Construction

| | Warp or Weft | | | | Tape | |
|---|---|---|---|---|---|---|
| | Tape Width | Gap | Gap | Porosity | Insertion | Coverage |
| Warp or Weft | mm | mm | mm2 | % | per 25.4 mm | % |
| 7.0 mm tapes | 7.0 | 0.53 | 0.28 | 0.50% | 3.4 | 92.9% |
| | 7.0 | 0.60 | 0.36 | 0.63% | 3.3 | 92.1% |
| | 7.0 | 0.70 | 0.49 | 0.83% | 3.3 | 90.9% |
| | 7.0 | 0.80 | 0.64 | 1.06% | 3.3 | 89.7% |
| | 7.0 | 0.90 | 0.81 | 1.31% | 3.2 | 88.6% |
| | 7.0 | 1.14 | 1.30 | 2.00% | 3.1 | 86.0% |
| 6.5 mm tapes | 6.5 | 0.49 | 0.24 | 0.50% | 3.6 | 93.0% |
| | 6.5 | 0.50 | 0.25 | 0.51% | 3.6 | 92.9% |
| | 6.5 | 0.60 | 0.36 | 0.72% | 3.6 | 91.5% |
| | 6.5 | 0.70 | 0.49 | 0.95% | 3.5 | 90.3% |
| | 6.5 | 0.80 | 0.64 | 1.22% | 3.5 | 89.0% |
| | 6.5 | 1.06 | 1.12 | 2.00% | 3.4 | 86.0% |
| 6.0 mm tapes | 6.0 | 0.46 | 0.21 | 0.50% | 3.9 | 92.9% |
| | 6.0 | 0.50 | 0.25 | 0.60% | 3.9 | 92.3% |
| | 6.0 | 0.60 | 0.36 | 0.83% | 3.8 | 90.9% |
| | 6.0 | 0.70 | 0.49 | 1.10% | 3.8 | 89.6% |
| | 6.0 | 0.80 | 0.64 | 1.40% | 3.7 | 88.2% |
| | 6.0 | 0.90 | 0.81 | 1.73% | 3.7 | 87.0% |
| | 6.0 | 0.98 | 0.95 | 2.00% | 3.6 | 86.0% |
| 5.5 mm tapes | 5.5 | 0.42 | 0.17 | 0.50% | 4.3 | 92.9% |
| | 5.5 | 0.50 | 0.25 | 0.70% | 4.2 | 91.7% |
| | 5.5 | 0.60 | 0.36 | 0.98% | 4.2 | 90.2% |
| | 5.5 | 0.70 | 0.49 | 1.29% | 4.1 | 88.7% |
| | 5.5 | 0.80 | 0.64 | 1.64% | 4.0 | 87.3% |
| | 5.5 | 0.90 | 0.80 | 2.00% | 4.0 | 86.0% |
| 5.0 mm tapes | 5.0 | 0.38 | 0.14 | 0.50% | 4.7 | 92.9% |
| | 5.0 | 0.40 | 0.16 | 0.55% | 4.7 | 92.6% |
| | 5.0 | 0.50 | 0.25 | 0.83% | 4.6 | 90.9% |
| | 5.0 | 0.60 | 0.36 | 1.16% | 4.5 | 89.3% |
| | 5.0 | 0.70 | 0.49 | 1.53% | 4.5 | 87.7% |
| | 5.0 | 0.80 | 0.64 | 1.94% | 4.4 | 86.2% |
| | 5.0 | 0.81 | 0.66 | 2.00% | 4.4 | 86.0% |
| 4.5 mm tapes | 4.5 | 0.34 | 0.12 | 0.50% | 5.2 | 92.9% |
| | 4.5 | 0.40 | 0.16 | 0.67% | 5.2 | 91.8% |
| | 4.5 | 0.50 | 0.25 | 1.01% | 5.1 | 90.0% |
| | 4.5 | 0.60 | 0.36 | 1.40% | 5.0 | 88.2% |
| | 4.5 | 0.70 | 0.49 | 1.85% | 4.9 | 86.5% |
| | 4.5 | 0.73 | 0.54 | 2.00% | 4.9 | 86.0% |
| 4.0 mm tapes | 4.0 | 0.30 | 0.09 | 0.50% | 5.9 | 92.9% |
| Open Stage One | 4.0 | 0.35 | 0.12 | 0.65% | 5.8 | 92.0% |
| | 4.0 | 0.40 | 0.16 | 0.83% | 5.8 | 90.9% |
| Open Stage Two | 4.0 | 0.50 | 0.25 | 1.25% | 5.6 | 88.9% |
| | 4.0 | 0.60 | 0.36 | 1.73% | 5.5 | 87.0% |
| Open Stage Three | 4.0 | 0.65 | 0.42 | 1.99% | 5.5 | 86.0% |
| | 4.0 | 0.65 | 0.42 | 2.00% | 5.5 | 86.0% |
| 3.5 mm tapes | 3.5 | 0.27 | 0.07 | 0.50% | 6.7 | 92.9% |
| | 3.5 | 0.30 | 0.09 | 0.63% | 6.7 | 92.1% |
| | 3.5 | 0.40 | 0.16 | 1.06% | 6.5 | 89.7% |
| | 3.5 | 0.50 | 0.25 | 1.59% | 6.4 | 87.5% |
| | 3.5 | 0.57 | 0.32 | 2.00% | 6.2 | 86.0% |
| 3.0 mm tapes | 3.0 | 0.23 | 0.05 | 0.50% | 7.9 | 92.9% |
| | 3.0 | 0.30 | 0.09 | 0.83% | 7.7 | 90.9% |
| | 3.0 | 0.40 | 0.16 | 1.40% | 7.5 | 88.2% |
| | 3.0 | 0.49 | 0.24 | 2.00% | 7.3 | 86.0% |
| 2.5 mm tapes | 2.5 | 0.19 | 0.04 | 0.50% | 9.4 | 92.9% |
| | 2.5 | 0.20 | 0.04 | 0.55% | 9.4 | 92.6% |
| | 2.5 | 0.30 | 0.09 | 1.16% | 9.1 | 89.3% |
| | 2.5 | 0.40 | 0.16 | 1.94% | 8.8 | 86.2% |
| | 2.5 | 0.41 | 0.17 | 2.00% | 8.7 | 86.0% |
| 2.0 mm tapes | 2.0 | 0.15 | 0.02 | 0.50% | 11.8 | 92.9% |
| | 2.0 | 0.20 | 0.04 | 0.83% | 11.5 | 90.9% |
| | 2.0 | 0.30 | 0.09 | 1.73% | 11.0 | 87.0% |
| | 2.0 | 0.33 | 0.11 | 2.00% | 10.9 | 86.0% |

| | | | | | | | | | |
|---|---|---|---|---|---|---|---|---|---|
| Tape | | Tape | | | | Tape | Tape | Coverage | Coverage |
| Width 1 | Gap 1 | Width 2 | Gap 2 | Gap | Porosity | Insertion 1 | Insertion 2 | 1 | 2 |
| mm | mm | mm | mm | mm2 | % | per 25.4 mm | per 25.4 mm | % | % |

2 to 7 mm Warp/Weft and 2.0 mm Warp/Weft Construction

| | | | | | | | | | | |
|---|---|---|---|---|---|---|---|---|---|---|
| 7.0 mm tapes | 7.0 | 0.53 | 2.0 | 0.15 | 0.08 | 0.50% | 3.4 | 11.8 | 92.9% | 92.9% |
| | 7.0 | 0.60 | 2.0 | 0.17 | 0.10 | 0.62% | 3.3 | 11.7 | 92.1% | 92.1% |
| | 7.0 | 0.70 | 2.0 | 0.20 | 0.14 | 0.83% | 3.3 | 11.5 | 90.9% | 90.9% |
| | 7.0 | 0.80 | 2.0 | 0.23 | 0.18 | 1.05% | 3.3 | 11.4 | 89.7% | 89.7% |
| | 7.0 | 0.90 | 2.0 | 0.26 | 0.23 | 1.30% | 3.2 | 11.3 | 88.6% | 88.6% |
| | 7.0 | 1.14 | 2.0 | 0.33 | 0.38 | 1.99% | 3.1 | 10.9 | 86.0% | 85.8% |
| 6.5 mm tapes | 6.5 | 0.49 | 2.0 | 0.15 | 0.08 | 0.50% | 3.6 | 11.8 | 93.0% | 92.9% |
| | 6.5 | 0.50 | 2.0 | 0.15 | 0.08 | 0.51% | 3.6 | 11.8 | 92.9% | 92.9% |
| | 6.5 | 0.60 | 2.0 | 0.18 | 0.11 | 0.71% | 3.6 | 11.6 | 91.5% | 91.5% |
| | 6.5 | 0.70 | 2.0 | 0.22 | 0.15 | 0.95% | 3.5 | 11.5 | 90.3% | 90.3% |
| | 6.5 | 0.80 | 2.0 | 0.25 | 0.20 | 1.20% | 3.5 | 11.3 | 89.0% | 89.0% |
| | 6.5 | 1.06 | 2.0 | 0.33 | 0.35 | 1.99% | 3.4 | 10.9 | 86.0% | 85.8% |
| 6.0 mm tapes | 6.0 | 0.46 | 2.0 | 0.16 | 0.07 | 0.52% | 3.9 | 11.8 | 92.9% | 92.6% |
| | 6.0 | 0.50 | 2.0 | 0.17 | 0.08 | 0.59% | 3.9 | 11.7 | 92.3% | 92.3% |
| | 6.0 | 0.60 | 2.0 | 0.20 | 0.12 | 0.83% | 3.8 | 11.5 | 90.9% | 90.9% |
| | 6.0 | 0.70 | 2.0 | 0.23 | 0.16 | 1.09% | 3.8 | 11.4 | 89.6% | 89.6% |
| | 6.0 | 0.80 | 2.0 | 0.27 | 0.21 | 1.38% | 3.7 | 11.2 | 88.2% | 88.2% |
| | 6.0 | 0.90 | 2.0 | 0.30 | 0.27 | 1.70% | 3.7 | 11.0 | 87.0% | 87.0% |
| | 6.0 | 0.98 | 2.0 | 0.33 | 0.32 | 1.99% | 3.6 | 10.9 | 86.0% | 85.8% |
| 5.5 mm tapes | 5.5 | 0.42 | 2.0 | 0.16 | 0.07 | 0.52% | 4.3 | 11.8 | 92.9% | 92.6% |
| | 5.5 | 0.50 | 2.0 | 0.18 | 0.09 | 0.69% | 4.2 | 11.6 | 91.7% | 91.7% |
| | 5.5 | 0.60 | 2.0 | 0.22 | 0.13 | 0.97% | 4.2 | 11.5 | 90.2% | 90.2% |
| | 5.5 | 0.70 | 2.0 | 0.25 | 0.18 | 1.27% | 4.1 | 11.3 | 88.7% | 88.7% |
| | 5.5 | 0.80 | 2.0 | 0.29 | 0.23 | 1.61% | 4.0 | 11.1 | 87.3% | 87.3% |
| | 5.5 | 0.90 | 2.0 | 0.33 | 0.30 | 1.99% | 4.0 | 10.9 | 86.0% | 85.8% |
| 5.0 mm tapes | 5.0 | 0.38 | 2.0 | 0.16 | 0.06 | 0.52% | 4.7 | 11.8 | 92.9% | 92.6% |
| | 5.0 | 0.40 | 2.0 | 0.16 | 0.06 | 0.55% | 4.7 | 11.8 | 92.6% | 92.6% |
| | 5.0 | 0.50 | 2.0 | 0.20 | 0.10 | 0.83% | 4.6 | 11.5 | 90.9% | 90.9% |
| | 5.0 | 0.60 | 2.0 | 0.24 | 0.14 | 1.15% | 4.5 | 11.3 | 89.3% | 89.3% |
| | 5.0 | 0.70 | 2.0 | 0.28 | 0.20 | 1.51% | 4.5 | 11.1 | 87.7% | 87.7% |
| | 5.0 | 0.80 | 2.0 | 0.32 | 0.26 | 1.90% | 4.4 | 11.0 | 86.2% | 86.2% |
| | 5.0 | 0.81 | 2.0 | 0.33 | 0.27 | 1.99% | 4.4 | 10.9 | 86.0% | 85.8% |
| 4.5 mm tapes | 4.5 | 0.34 | 2.0 | 0.16 | 0.05 | 0.52% | 5.2 | 11.8 | 92.9% | 92.7% |
| | 4.5 | 0.40 | 2.0 | 0.18 | 0.07 | 0.67% | 5.2 | 11.7 | 91.8% | 91.8% |
| | 4.5 | 0.50 | 2.0 | 0.22 | 0.11 | 1.00% | 5.1 | 11.4 | 90.0% | 90.0% |
| | 4.5 | 0.60 | 2.0 | 0.27 | 0.16 | 1.38% | 5.0 | 11.2 | 88.2% | 88.2% |
| | 4.5 | 0.70 | 2.0 | 0.31 | 0.22 | 1.81% | 4.9 | 11.0 | 86.5% | 86.5% |
| | 4.5 | 0.73 | 2.0 | 0.33 | 0.24 | 1.99% | 4.9 | 10.9 | 86.0% | 85.8% |
| 4.0 mm tapes | 4.0 | 0.30 | 2.0 | 0.16 | 0.05 | 0.52% | 5.9 | 11.8 | 92.9% | 92.7% |
| Open Stage One | 4.0 | 0.35 | 2.0 | 0.18 | 0.06 | 0.65% | 5.8 | 11.7 | 92.0% | 92.0% |
| | 4.0 | 0.40 | 2.0 | 0.20 | 0.08 | 0.83% | 5.8 | 11.5 | 90.9% | 90.9% |
| Open Stage Two | 4.0 | 0.50 | 2.0 | 0.25 | 0.13 | 1.23% | 5.6 | 11.3 | 88.9% | 88.9% |
| | 4.0 | 0.60 | 2.0 | 0.30 | 0.18 | 1.70% | 5.5 | 11.0 | 87.0% | 87.0% |
| Open Stage Three | 4.0 | 0.65 | 2.0 | 0.33 | 0.21 | 1.95% | 5.5 | 10.9 | 86.0% | 86.0% |
| | 4.0 | 0.65 | 2.0 | 0.33 | 0.22 | 1.99% | 5.5 | 10.9 | 86.0% | 85.8% |
| 3.5 mm tapes | 3.5 | 0.27 | 2.0 | 0.16 | 0.04 | 0.51% | 6.7 | 11.8 | 92.9% | 92.7% |
| | 3.5 | 0.30 | 2.0 | 0.17 | 0.05 | 0.62% | 6.7 | 11.7 | 92.1% | 92.1% |
| | 3.5 | 0.40 | 2.0 | 0.23 | 0.09 | 1.05% | 6.5 | 11.4 | 89.7% | 89.7% |
| | 3.5 | 0.50 | 2.0 | 0.29 | 0.14 | 1.56% | 6.4 | 11.1 | 87.5% | 87.5% |
| | 3.5 | 0.57 | 2.0 | 0.33 | 0.19 | 1.99% | 6.2 | 10.9 | 86.0% | 85.8% |
| 3.0 mm tapes | 3.0 | 0.23 | 2.0 | 0.16 | 0.04 | 0.51% | 7.9 | 11.8 | 92.9% | 92.8% |
| | 3.0 | 0.30 | 2.0 | 0.20 | 0.06 | 0.83% | 7.7 | 11.5 | 90.9% | 90.9% |
| | 3.0 | 0.40 | 2.0 | 0.27 | 0.11 | 1.38% | 7.5 | 11.2 | 88.2% | 88.2% |
| | 3.0 | 0.49 | 2.0 | 0.33 | 0.16 | 1.99% | 7.3 | 10.9 | 86.0% | 85.8% |
| 2.5 mm tapes | 2.5 | 0.19 | 2.0 | 0.15 | 0.03 | 0.51% | 9.4 | 11.8 | 92.9% | 92.8% |
| | 2.5 | 0.20 | 2.0 | 0.16 | 0.03 | 0.55% | 9.4 | 11.8 | 92.6% | 92.6% |
| | 2.5 | 0.30 | 2.0 | 0.24 | 0.07 | 1.15% | 9.1 | 11.3 | 89.3% | 89.3% |
| | 2.5 | 0.40 | 2.0 | 0.32 | 0.13 | 1.90% | 8.8 | 11.0 | 86.2% | 86.2% |
| | 2.5 | 0.41 | 2.0 | 0.33 | 0.14 | 1.99% | 8.7 | 10.9 | 86.0% | 85.8% |
| 2.0 mm tapes | 2.0 | 0.15 | 2.0 | 0.15 | 0.02 | 0.50% | 11.8 | 11.8 | 92.9% | 92.9% |
| | 2.0 | 0.20 | 2.0 | 0.20 | 0.04 | 0.83% | 11.5 | 11.5 | 90.9% | 90.9% |
| | 2.0 | 0.30 | 2.0 | 0.30 | 0.09 | 1.70% | 11.0 | 11.0 | 87.0% | 87.0% |
| | 2.0 | 0.33 | 2.0 | 0.33 | 0.11 | 1.99% | 10.9 | 10.9 | 86.0% | 85.8% |

2 to 7 mm Warp/Weft and 2.5 mm Warp/Weft Construction

| | | | | | | | | | | |
|---|---|---|---|---|---|---|---|---|---|---|
| 7.0 mm tapes | 7.0 | 0.53 | 2.5 | 0.19 | 0.10 | 0.50% | 3.4 | 9.4 | 92.9% | 92.9% |
| | 7.0 | 0.60 | 2.5 | 0.21 | 0.13 | 0.62% | 3.3 | 9.4 | 92.1% | 92.1% |
| | 7.0 | 0.70 | 2.5 | 0.25 | 0.18 | 0.83% | 3.3 | 9.2 | 90.9% | 90.9% |
| | 7.0 | 0.80 | 2.5 | 0.29 | 0.23 | 1.05% | 3.3 | 9.1 | 89.7% | 89.7% |
| | 7.0 | 0.90 | 2.5 | 0.32 | 0.29 | 1.30% | 3.2 | 9.0 | 88.6% | 88.6% |
| | 7.0 | 1.14 | 2.5 | 0.42 | 0.47 | 1.99% | 3.1 | 8.7 | 86.0% | 85.8% |
| 6.5 mm tapes | 6.5 | 0.49 | 2.5 | 0.19 | 0.09 | 0.50% | 3.6 | 9.4 | 93.0% | 92.9% |
| | 6.5 | 0.50 | 2.5 | 0.19 | 0.10 | 0.51% | 3.6 | 9.4 | 92.9% | 92.9% |
| | 6.5 | 0.60 | 2.5 | 0.23 | 0.14 | 0.71% | 3.6 | 9.3 | 91.5% | 91.5% |
| | 6.5 | 0.70 | 2.5 | 0.27 | 0.19 | 0.95% | 3.5 | 9.2 | 90.3% | 90.3% |
| | 6.5 | 0.80 | 2.5 | 0.31 | 0.25 | 1.20% | 3.5 | 9.0 | 89.0% | 89.0% |
| | 6.5 | 1.06 | 2.5 | 0.42 | 0.44 | 1.99% | 3.4 | 8.7 | 86.0% | 85.8% |
| 6.0 mm tapes | 6.0 | 0.46 | 2.5 | 0.20 | 0.09 | 0.52% | 3.9 | 9.4 | 92.9% | 92.6% |
| | 6.0 | 0.50 | 2.5 | 0.21 | 0.10 | 0.59% | 3.9 | 9.4 | 92.3% | 92.3% |
| | 6.0 | 0.60 | 2.5 | 0.25 | 0.15 | 0.83% | 3.8 | 9.2 | 90.9% | 90.9% |
| | 6.0 | 0.70 | 2.5 | 0.29 | 0.20 | 1.09% | 3.8 | 9.1 | 89.6% | 89.6% |
| | 6.0 | 0.80 | 2.5 | 0.33 | 0.27 | 1.38% | 3.7 | 9.0 | 88.2% | 88.2% |
| | 6.0 | 0.90 | 2.5 | 0.38 | 0.34 | 1.70% | 3.7 | 8.8 | 87.0% | 87.0% |
| | 6.0 | 0.98 | 2.5 | 0.42 | 0.41 | 1.99% | 3.6 | 8.7 | 86.0% | 85.8% |
| 5.5 mm tapes | 5.5 | 0.42 | 2.5 | 0.20 | 0.08 | 0.52% | 4.3 | 9.4 | 92.9% | 92.6% |
| | 5.5 | 0.50 | 2.5 | 0.23 | 0.11 | 0.69% | 4.2 | 9.3 | 91.7% | 91.7% |
| | 5.5 | 0.60 | 2.5 | 0.27 | 0.16 | 0.97% | 4.2 | 9.2 | 90.2% | 90.2% |
| | 5.5 | 0.70 | 2.5 | 0.32 | 0.22 | 1.27% | 4.1 | 9.0 | 88.7% | 88.7% |
| | 5.5 | 0.80 | 2.5 | 0.36 | 0.29 | 1.61% | 4.0 | 8.9 | 87.3% | 87.3% |
| | 5.5 | 0.90 | 2.5 | 0.42 | 0.37 | 1.99% | 4.0 | 8.7 | 86.0% | 85.8% |
| 5.0 mm tapes | 5.0 | 0.38 | 2.5 | 0.20 | 0.08 | 0.52% | 4.7 | 9.4 | 92.9% | 92.6% |
| | 5.0 | 0.40 | 2.5 | 0.20 | 0.08 | 0.55% | 4.7 | 9.4 | 92.6% | 92.6% |
| | 5.0 | 0.50 | 2.5 | 0.25 | 0.13 | 0.83% | 4.6 | 9.2 | 90.9% | 90.9% |
| | 5.0 | 0.60 | 2.5 | 0.30 | 0.18 | 1.15% | 4.5 | 9.1 | 89.3% | 89.3% |
| | 5.0 | 0.70 | 2.5 | 0.35 | 0.25 | 1.51% | 4.5 | 8.9 | 87.7% | 87.7% |
| | 5.0 | 0.80 | 2.5 | 0.40 | 0.32 | 1.90% | 4.4 | 8.8 | 86.2% | 86.2% |
| | 5.0 | 0.81 | 2.5 | 0.42 | 0.34 | 1.99% | 4.4 | 8.7 | 86.0% | 85.8% |
| 4.5 mm tapes | 4.5 | 0.34 | 2.5 | 0.20 | 0.07 | 0.52% | 5.2 | 9.4 | 92.9% | 92.7% |
| | 4.5 | 0.40 | 2.5 | 0.22 | 0.09 | 0.67% | 5.2 | 9.3 | 91.8% | 91.8% |
| | 4.5 | 0.50 | 2.5 | 0.28 | 0.14 | 1.00% | 5.1 | 9.1 | 90.0% | 90.0% |
| | 4.5 | 0.60 | 2.5 | 0.33 | 0.20 | 1.38% | 5.0 | 9.0 | 88.2% | 88.2% |
| | 4.5 | 0.70 | 2.5 | 0.39 | 0.27 | 1.81% | 4.9 | 8.8 | 86.5% | 86.5% |
| | 4.5 | 0.73 | 2.5 | 0.42 | 0.30 | 1.99% | 4.9 | 8.7 | 86.0% | 85.8% |
| 4.0 mm tapes | 4.0 | 0.30 | 2.5 | 0.20 | 0.06 | 0.52% | 5.9 | 9.4 | 92.9% | 92.7% |
| Open Stage One | 4.0 | 0.35 | 2.5 | 0.22 | 0.08 | 0.65% | 5.8 | 9.3 | 92.0% | 92.0% |
| | 4.0 | 0.40 | 2.5 | 0.25 | 0.10 | 0.83% | 5.8 | 9.2 | 90.9% | 90.9% |
| Open Stage Two | 4.0 | 0.50 | 2.5 | 0.31 | 0.16 | 1.23% | 5.6 | 9.0 | 88.9% | 88.9% |
| | 4.0 | 0.60 | 2.5 | 0.38 | 0.23 | 1.70% | 5.5 | 8.8 | 87.0% | 87.0% |
| Open Stage Three | 4.0 | 0.65 | 2.5 | 0.41 | 0.26 | 1.95% | 5.5 | 8.7 | 86.0% | 86.0% |
| | 4.0 | 0.65 | 2.5 | 0.42 | 0.27 | 1.99% | 5.5 | 8.7 | 86.0% | 85.8% |
| 3.5 mm tapes | 3.5 | 0.27 | 2.5 | 0.20 | 0.05 | 0.51% | 6.7 | 9.4 | 92.9% | 92.7% |
| | 3.5 | 0.30 | 2.5 | 0.21 | 0.06 | 0.62% | 6.7 | 9.4 | 92.1% | 92.1% |
| | 3.5 | 0.40 | 2.5 | 0.29 | 0.11 | 1.05% | 6.5 | 9.1 | 89.7% | 89.7% |
| | 3.5 | 0.50 | 2.5 | 0.36 | 0.18 | 1.56% | 6.4 | 8.9 | 87.5% | 87.5% |
| | 3.5 | 0.57 | 2.5 | 0.42 | 0.24 | 1.99% | 6.2 | 8.7 | 86.0% | 85.8% |
| 3.0 mm tapes | 3.0 | 0.23 | 2.5 | 0.20 | 0.04 | 0.51% | 7.9 | 9.4 | 92.9% | 92.8% |
| | 3.0 | 0.30 | 2.5 | 0.25 | 0.07 | 0.83% | 7.7 | 9.2 | 90.9% | 90.9% |
| | 3.0 | 0.40 | 2.5 | 0.33 | 0.13 | 1.38% | 7.5 | 9.0 | 88.2% | 88.2% |
| | 3.0 | 0.49 | 2.5 | 0.42 | 0.20 | 1.99% | 7.3 | 8.7 | 86.0% | 85.8% |
| 2.5 mm tapes | 2.5 | 0.19 | 2.5 | 0.19 | 0.04 | 0.51% | 9.4 | 9.4 | 92.9% | 92.8% |
| | 2.5 | 0.20 | 2.5 | 0.20 | 0.04 | 0.55% | 9.4 | 9.4 | 92.6% | 92.6% |
| | 2.5 | 0.30 | 2.5 | 0.30 | 0.09 | 1.15% | 9.1 | 9.1 | 89.3% | 89.3% |
| | 2.5 | 0.40 | 2.5 | 0.40 | 0.16 | 1.90% | 8.8 | 8.8 | 86.2% | 86.2% |
| | 2.5 | 0.41 | 2.5 | 0.42 | 0.17 | 1.99% | 8.7 | 8.7 | 86.0% | 85.8% |
| 2.0 mm tapes | 2.0 | 0.15 | 2.5 | 0.19 | 0.03 | 0.50% | 11.8 | 9.4 | 92.9% | 92.9% |
| | 2.0 | 0.20 | 2.5 | 0.25 | 0.05 | 0.83% | 11.5 | 9.2 | 90.9% | 90.9% |
| | 2.0 | 0.30 | 2.5 | 0.38 | 0.11 | 1.70% | 11.0 | 8.8 | 87.0% | 87.0% |
| | 2.0 | 0.33 | 2.5 | 0.42 | 0.14 | 1.99% | 10.9 | 8.7 | 86.0% | 85.8% |

2 to 7 mm Warp/Weft and 3.0 mm Warp/Weft Construction

| | | | | | | | | | | |
|---|---|---|---|---|---|---|---|---|---|---|
| 7.0 mm tapes | 7.0 | 0.53 | 3.0 | 0.23 | 0.12 | 0.50% | 3.4 | 7.9 | 92.9% | 92.9% |
| | 7.0 | 0.60 | 3.0 | 0.26 | 0.15 | 0.62% | 3.3 | 7.8 | 92.1% | 92.1% |
| | 7.0 | 0.70 | 3.0 | 0.30 | 0.21 | 0.83% | 3.3 | 7.7 | 90.9% | 90.9% |
| | 7.0 | 0.80 | 3.0 | 0.34 | 0.27 | 1.05% | 3.3 | 7.6 | 89.7% | 89.7% |
| | 7.0 | 0.90 | 3.0 | 0.39 | 0.35 | 1.30% | 3.2 | 7.5 | 88.6% | 88.6% |
| | 7.0 | 1.14 | 3.0 | 0.50 | 0.57 | 1.99% | 3.1 | 7.3 | 86.0% | 85.8% |
| 6.5 mm tapes | 6.5 | 0.49 | 3.0 | 0.23 | 0.11 | 0.50% | 3.6 | 7.9 | 93.0% | 92.9% |
| | 6.5 | 0.50 | 3.0 | 0.23 | 0.12 | 0.51% | 3.6 | 7.9 | 92.9% | 92.9% |
| | 6.5 | 0.60 | 3.0 | 0.28 | 0.17 | 0.71% | 3.6 | 7.8 | 91.5% | 91.5% |
| | 6.5 | 0.70 | 3.0 | 0.32 | 0.23 | 0.95% | 3.5 | 7.6 | 90.3% | 90.3% |
| | 6.5 | 0.80 | 3.0 | 0.37 | 0.30 | 1.20% | 3.5 | 7.5 | 89.0% | 89.0% |
| | 6.5 | 1.06 | 3.0 | 0.50 | 0.53 | 1.99% | 3.4 | 7.3 | 86.0% | 85.8% |
| 6.0 mm tapes | 6.0 | 0.46 | 3.0 | 0.24 | 0.11 | 0.52% | 3.9 | 7.8 | 92.9% | 92.6% |
| | 6.0 | 0.50 | 3.0 | 0.25 | 0.13 | 0.59% | 3.9 | 7.8 | 92.3% | 92.3% |
| | 6.0 | 0.60 | 3.0 | 0.30 | 0.18 | 0.83% | 3.8 | 7.7 | 90.9% | 90.9% |
| | 6.0 | 0.70 | 3.0 | 0.35 | 0.25 | 1.09% | 3.8 | 7.6 | 89.6% | 89.6% |
| | 6.0 | 0.80 | 3.0 | 0.40 | 0.32 | 1.38% | 3.7 | 7.5 | 88.2% | 88.2% |
| | 6.0 | 0.90 | 3.0 | 0.45 | 0.41 | 1.70% | 3.7 | 7.4 | 87.0% | 87.0% |
| | 6.0 | 0.98 | 3.0 | 0.50 | 0.49 | 1.99% | 3.6 | 7.3 | 86.0% | 85.8% |
| 5.5 mm tapes | 5.5 | 0.42 | 3.0 | 0.24 | 0.10 | 0.52% | 4.3 | 7.8 | 92.9% | 92.6% |
| | 5.5 | 0.50 | 3.0 | 0.27 | 0.14 | 0.69% | 4.2 | 7.8 | 91.7% | 91.7% |
| | 5.5 | 0.60 | 3.0 | 0.33 | 0.20 | 0.97% | 4.2 | 7.6 | 90.2% | 90.2% |
| | 5.5 | 0.70 | 3.0 | 0.38 | 0.27 | 1.27% | 4.1 | 7.5 | 88.7% | 88.7% |
| | 5.5 | 0.80 | 3.0 | 0.44 | 0.35 | 1.61% | 4.0 | 7.4 | 87.3% | 87.3% |
| | 5.5 | 0.90 | 3.0 | 0.50 | 0.45 | 1.99% | 4.0 | 7.3 | 86.0% | 85.8% |
| 5.0 mm tapes | 5.0 | 0.38 | 3.0 | 0.24 | 0.09 | 0.52% | 4.7 | 7.8 | 92.9% | 92.6% |
| | 5.0 | 0.40 | 3.0 | 0.24 | 0.10 | 0.55% | 4.7 | 7.8 | 92.6% | 92.6% |
| | 5.0 | 0.50 | 3.0 | 0.30 | 0.15 | 0.83% | 4.6 | 7.7 | 90.9% | 90.9% |
| | 5.0 | 0.60 | 3.0 | 0.36 | 0.22 | 1.15% | 4.5 | 7.6 | 89.3% | 89.3% |
| | 5.0 | 0.70 | 3.0 | 0.42 | 0.29 | 1.51% | 4.5 | 7.4 | 87.7% | 87.7% |
| | 5.0 | 0.80 | 3.0 | 0.48 | 0.38 | 1.90% | 4.4 | 7.3 | 86.2% | 86.2% |
| | 5.0 | 0.81 | 3.0 | 0.50 | 0.41 | 1.99% | 4.4 | 7.3 | 86.0% | 85.8% |
| 4.5 mm tapes | 4.5 | 0.34 | 3.0 | 0.24 | 0.08 | 0.52% | 5.2 | 7.8 | 92.9% | 92.7% |
| | 4.5 | 0.40 | 3.0 | 0.27 | 0.11 | 0.67% | 5.2 | 7.8 | 91.8% | 91.8% |
| | 4.5 | 0.50 | 3.0 | 0.33 | 0.17 | 1.00% | 5.1 | 7.6 | 90.0% | 90.0% |
| | 4.5 | 0.60 | 3.0 | 0.40 | 0.24 | 1.38% | 5.0 | 7.5 | 88.2% | 88.2% |
| | 4.5 | 0.70 | 3.0 | 0.47 | 0.33 | 1.81% | 4.9 | 7.3 | 86.5% | 86.5% |
| | 4.5 | 0.73 | 3.0 | 0.50 | 0.36 | 1.99% | 4.9 | 7.3 | 86.0% | 85.8% |
| 4.0 mm tapes | 4.0 | 0.30 | 3.0 | 0.24 | 0.07 | 0.52% | 5.9 | 7.8 | 92.9% | 92.7% |
| Open Stage One | 4.0 | 0.35 | 3.0 | 0.26 | 0.09 | 0.65% | 5.8 | 7.8 | 92.0% | 92.0% |
| | 4.0 | 0.40 | 3.0 | 0.30 | 0.12 | 0.83% | 5.8 | 7.7 | 90.9% | 90.9% |
| Open Stage Two | 4.0 | 0.50 | 3.0 | 0.38 | 0.19 | 1.23% | 5.6 | 7.5 | 88.9% | 88.9% |
| | 4.0 | 0.60 | 3.0 | 0.45 | 0.27 | 1.70% | 5.5 | 7.4 | 87.0% | 87.0% |
| Open Stage Three | 4.0 | 0.65 | 3.0 | 0.49 | 0.32 | 1.95% | 5.5 | 7.3 | 86.0% | 86.0% |
| | 4.0 | 0.65 | 3.0 | 0.50 | 0.32 | 1.99% | 5.5 | 7.3 | 86.0% | 85.8% |
| 3.5 mm tapes | 3.5 | 0.27 | 3.0 | 0.24 | 0.06 | 0.51% | 6.7 | 7.8 | 92.9% | 92.7% |
| | 3.5 | 0.30 | 3.0 | 0.26 | 0.08 | 0.62% | 6.7 | 7.8 | 92.1% | 92.1% |
| | 3.5 | 0.40 | 3.0 | 0.34 | 0.14 | 1.05% | 6.5 | 7.6 | 89.7% | 89.7% |
| | 3.5 | 0.50 | 3.0 | 0.43 | 0.21 | 1.56% | 6.4 | 7.4 | 87.5% | 87.5% |
| | 3.5 | 0.57 | 3.0 | 0.50 | 0.28 | 1.99% | 6.2 | 7.3 | 86.0% | 85.8% |
| 3.0 mm tapes | 3.0 | 0.23 | 3.0 | 0.23 | 0.05 | 0.51% | 7.9 | 7.9 | 92.9% | 92.8% |
| | 3.0 | 0.30 | 3.0 | 0.30 | 0.09 | 0.83% | 7.7 | 7.7 | 90.9% | 90.9% |
| | 3.0 | 0.40 | 3.0 | 0.40 | 0.16 | 1.38% | 7.5 | 7.5 | 88.2% | 88.2% |
| | 3.0 | 0.49 | 3.0 | 0.50 | 0.24 | 1.99% | 7.3 | 7.3 | 86.0% | 85.8% |
| 2.5 mm tapes | 2.5 | 0.19 | 3.0 | 0.23 | 0.04 | 0.51% | 9.4 | 7.9 | 92.9% | 92.8% |
| | 2.5 | 0.20 | 3.0 | 0.24 | 0.05 | 0.55% | 9.4 | 7.8 | 92.6% | 92.6% |
| | 2.5 | 0.30 | 3.0 | 0.36 | 0.11 | 1.15% | 9.1 | 7.6 | 89.3% | 89.3% |
| | 2.5 | 0.40 | 3.0 | 0.48 | 0.19 | 1.90% | 8.8 | 7.3 | 86.2% | 86.2% |
| | 2.5 | 0.41 | 3.0 | 0.50 | 0.20 | 1.99% | 8.7 | 7.3 | 86.0% | 85.8% |
| 2.0 mm tapes | 2.0 | 0.15 | 3.0 | 0.23 | 0.03 | 0.50% | 11.8 | 7.9 | 92.9% | 92.9% |
| | 2.0 | 0.20 | 3.0 | 0.30 | 0.06 | 0.83% | 11.5 | 7.7 | 90.9% | 90.9% |
| | 2.0 | 0.30 | 3.0 | 0.45 | 0.14 | 1.70% | 11.0 | 7.4 | 87.0% | 87.0% |
| | 2.0 | 0.33 | 3.0 | 0.50 | 0.16 | 1.99% | 10.9 | 7.3 | 86.0% | 85.8% |

2 to 7 mm Warp/Weft and 3.5 mm Warp/Weft Construction

| | | | | | | | | | | |
|---|---|---|---|---|---|---|---|---|---|---|
| 7.0 mm tapes | 7.0 | 0.53 | 3.5 | 0.27 | 0.14 | 0.50% | 3.4 | 6.7 | 92.9% | 92.9% |
| | 7.0 | 0.60 | 3.5 | 0.30 | 0.18 | 0.62% | 3.3 | 6.7 | 92.1% | 92.1% |
| | 7.0 | 0.70 | 3.5 | 0.35 | 0.25 | 0.83% | 3.3 | 6.6 | 90.9% | 90.9% |
| | 7.0 | 0.80 | 3.5 | 0.40 | 0.32 | 1.05% | 3.3 | 6.5 | 89.7% | 89.7% |
| | 7.0 | 0.90 | 3.5 | 0.45 | 0.41 | 1.30% | 3.2 | 6.4 | 88.6% | 88.6% |
| | 7.0 | 1.14 | 3.5 | 0.58 | 0.66 | 1.99% | 3.1 | 6.2 | 86.0% | 85.8% |
| 6.5 mm tapes | 6.5 | 0.49 | 3.5 | 0.27 | 0.13 | 0.50% | 3.6 | 6.7 | 93.0% | 92.9% |
| | 6.5 | 0.50 | 3.5 | 0.27 | 0.13 | 0.51% | 3.6 | 6.7 | 92.9% | 92.9% |
| | 6.5 | 0.60 | 3.5 | 0.32 | 0.19 | 0.71% | 3.6 | 6.6 | 91.5% | 91.5% |
| | 6.5 | 0.70 | 3.5 | 0.38 | 0.26 | 0.95% | 3.5 | 6.6 | 90.3% | 90.3% |
| | 6.5 | 0.80 | 3.5 | 0.43 | 0.34 | 1.20% | 3.5 | 6.5 | 89.0% | 89.0% |
| | 6.5 | 1.06 | 3.5 | 0.58 | 0.62 | 1.99% | 3.4 | 6.2 | 86.0% | 85.8% |
| 6.0 mm tapes | 6.0 | 0.46 | 3.5 | 0.28 | 0.13 | 0.52% | 3.9 | 6.7 | 92.9% | 92.6% |
| | 6.0 | 0.50 | 3.5 | 0.29 | 0.15 | 0.59% | 3.9 | 6.7 | 92.3% | 92.3% |
| | 6.0 | 0.60 | 3.5 | 0.35 | 0.21 | 0.83% | 3.8 | 6.6 | 90.9% | 90.9% |
| | 6.0 | 0.70 | 3.5 | 0.41 | 0.29 | 1.09% | 3.8 | 6.5 | 89.6% | 89.6% |
| | 6.0 | 0.80 | 3.5 | 0.47 | 0.37 | 1.38% | 3.7 | 6.4 | 88.2% | 88.2% |
| | 6.0 | 0.90 | 3.5 | 0.53 | 0.47 | 1.70% | 3.7 | 6.3 | 87.0% | 87.0% |
| | 6.0 | 0.98 | 4.5 | 0.58 | 0.57 | 1.99% | 3.6 | 6.2 | 86.0% | 85.8% |
| 5.5 mm tapes | 5.5 | 0.42 | 3.5 | 0.28 | 0.12 | 0.52% | 4.3 | 6.7 | 92.9% | 92.6% |
| | 5.5 | 0.50 | 3.5 | 0.32 | 0.16 | 0.69% | 4.2 | 6.7 | 91.7% | 91.7% |
| | 5.5 | 0.60 | 3.5 | 0.38 | 0.23 | 0.97% | 4.2 | 6.5 | 90.2% | 90.2% |
| | 5.5 | 0.70 | 3.5 | 0.45 | 0.31 | 1.27% | 4.1 | 6.4 | 88.7% | 88.7% |
| | 5.5 | 0.80 | 3.5 | 0.51 | 0.41 | 1.61% | 4.0 | 6.3 | 87.3% | 87.3% |
| | 5.5 | 0.90 | 3.5 | 0.58 | 0.52 | 1.99% | 4.0 | 6.2 | 86.0% | 85.8% |
| 5.0 mm tapes | 5.0 | 0.38 | 3.5 | 0.28 | 0.11 | 0.52% | 4.7 | 6.7 | 92.9% | 92.6% |
| | 5.0 | 0.40 | 3.5 | 0.28 | 0.11 | 0.55% | 4.7 | 6.7 | 92.6% | 92.6% |
| | 5.0 | 0.50 | 3.5 | 0.35 | 0.18 | 0.83% | 4.6 | 6.6 | 90.9% | 90.9% |
| | 5.0 | 0.60 | 3.5 | 0.42 | 0.25 | 1.15% | 4.5 | 6.5 | 89.3% | 89.3% |
| | 5.0 | 0.70 | 3.5 | 0.49 | 0.34 | 1.51% | 4.5 | 6.4 | 87.7% | 87.7% |
| | 5.0 | 0.80 | 3.5 | 0.56 | 0.45 | 1.90% | 4.4 | 6.3 | 86.2% | 86.2% |
| | 5.0 | 0.81 | 3.5 | 0.58 | 0.47 | 1.99% | 4.4 | 6.2 | 86.0% | 85.8% |
| 4.5 mm tapes | 4.5 | 0.34 | 3.5 | 0.28 | 0.09 | 0.52% | 5.2 | 6.7 | 92.9% | 92.7% |
| | 4.5 | 0.40 | 3.5 | 0.31 | 0.12 | 0.67% | 5.2 | 6.7 | 91.8% | 91.8% |
| | 4.5 | 0.50 | 3.5 | 0.39 | 0.19 | 1.00% | 5.1 | 6.5 | 90.0% | 90.0% |
| | 4.5 | 0.60 | 3.5 | 0.47 | 0.28 | 1.38% | 5.0 | 6.4 | 88.2% | 88.2% |
| | 4.5 | 0.70 | 3.5 | 0.54 | 0.38 | 1.81% | 4.9 | 6.3 | 86.5% | 86.5% |
| | 4.5 | 0.73 | 3.5 | 0.58 | 0.43 | 1.99% | 4.9 | 6.2 | 86.0% | 85.8% |
| 4.0 mm tapes | 4.0 | 0.30 | 3.5 | 0.28 | 0.08 | 0.52% | 5.9 | 6.7 | 92.9% | 92.7% |
| Open Stage One | 4.0 | 0.35 | 3.5 | 0.31 | 0.11 | 0.65% | 5.8 | 6.7 | 92.0% | 92.0% |
| | 4.0 | 0.40 | 3.5 | 0.35 | 0.14 | 0.83% | 5.8 | 6.6 | 90.9% | 90.9% |
| Open Stage Two | 4.0 | 0.50 | 3.5 | 0.44 | 0.22 | 1.23% | 5.6 | 6.5 | 88.9% | 88.9% |
| | 4.0 | 0.60 | 3.5 | 0.52 | 0.32 | 1.70% | 5.5 | 6.3 | 87.0% | 87.0% |
| Open Stage Three | 4.0 | 0.65 | 3.5 | 0.57 | 0.37 | 1.95% | 5.5 | 6.2 | 86.0% | 86.0% |
| | 4.0 | 0.65 | 3.5 | 0.58 | 0.38 | 1.99% | 5.5 | 6.2 | 86.0% | 85.8% |
| 3.5 mm tapes | 3.5 | 0.27 | 3.5 | 0.28 | 0.07 | 0.51% | 6.7 | 6.7 | 92.9% | 92.7% |
| | 3.5 | 0.30 | 3.5 | 0.30 | 0.09 | 0.62% | 6.7 | 6.7 | 92.1% | 92.1% |
| | 3.5 | 0.40 | 3.5 | 0.40 | 0.16 | 1.05% | 6.5 | 6.5 | 89.7% | 89.7% |
| | 3.5 | 0.50 | 3.5 | 0.50 | 0.25 | 1.56% | 6.4 | 6.4 | 87.5% | 87.5% |
| | 3.5 | 0.57 | 3.5 | 0.58 | 0.33 | 1.99% | 6.2 | 6.2 | 86.0% | 85.8% |
| 3.0 mm tapes | 3.0 | 0.23 | 3.5 | 0.27 | 0.06 | 0.51% | 7.9 | 6.7 | 92.9% | 92.8% |
| | 3.0 | 0.30 | 3.5 | 0.35 | 0.11 | 0.83% | 7.7 | 6.6 | 90.9% | 90.9% |
| | 3.0 | 0.40 | 3.5 | 0.47 | 0.19 | 1.38% | 7.5 | 6.4 | 88.2% | 88.2% |
| | 3.0 | 0.49 | 3.5 | 0.58 | 0.28 | 1.99% | 7.3 | 6.2 | 86.0% | 85.8% |
| 2.5 mm tapes | 2.5 | 0.19 | 3.5 | 0.27 | 0.05 | 0.51% | 9.4 | 6.7 | 92.9% | 92.8% |
| | 2.5 | 0.20 | 3.5 | 0.28 | 0.06 | 0.55% | 9.4 | 6.7 | 92.6% | 92.6% |
| | 2.5 | 0.30 | 3.5 | 0.42 | 0.13 | 1.15% | 9.1 | 6.5 | 89.3% | 89.3% |
| | 2.5 | 0.40 | 3.5 | 0.56 | 0.22 | 1.90% | 8.8 | 6.3 | 86.2% | 86.2% |
| | 2.5 | 0.41 | 3.5 | 0.58 | 0.24 | 1.99% | 8.7 | 6.2 | 86.0% | 85.8% |
| 2.0 mm tapes | 2.0 | 0.15 | 3.5 | 0.27 | 0.04 | 0.50% | 11.8 | 6.7 | 92.9% | 92.9% |
| | 2.0 | 0.20 | 3.5 | 0.35 | 0.07 | 0.83% | 11.5 | 6.6 | 90.9% | 90.9% |
| | 2.0 | 0.30 | 3.5 | 0.52 | 0.16 | 1.70% | 11.0 | 6.3 | 87.0% | 87.0% |
| | 2.0 | 0.33 | 3.5 | 0.58 | 0.19 | 1.99% | 10.9 | 6.2 | 86.0% | 85.8% |

2 to 7 mm Warp/Weft and 4.0 mm Warp/Weft Construction

| | | | | | | | | | | |
|---|---|---|---|---|---|---|---|---|---|---|
| 7.0 mm tapes | 7.0 | 0.53 | 4.0 | 0.30 | 0.16 | 0.50% | 3.4 | 5.90 | 92.9% | 92.9% |
| | 7.0 | 0.60 | 4.0 | 0.34 | 0.21 | 0.62% | 3.3 | 5.85 | 92.1% | 92.1% |
| | 7.0 | 0.70 | 4.0 | 0.40 | 0.28 | 0.83% | 3.3 | 5.77 | 90.9% | 90.9% |
| | 7.0 | 0.80 | 4.0 | 0.46 | 0.37 | 1.05% | 3.3 | 5.70 | 89.7% | 89.7% |
| | 7.0 | 0.90 | 4.0 | 0.51 | 0.46 | 1.30% | 3.2 | 5.63 | 88.6% | 88.6% |
| | 7.0 | 1.14 | 4.0 | 0.66 | 0.76 | 1.99% | 3.1 | 5.45 | 86.0% | 85.8% |
| 6.5 mm tapes | 6.5 | 0.49 | 4.0 | 0.31 | 0.15 | 0.50% | 3.6 | 5.90 | 93.0% | 92.9% |
| | 6.5 | 0.50 | 4.0 | 0.31 | 0.15 | 0.51% | 3.6 | 5.90 | 92.9% | 92.9% |
| | 6.5 | 0.60 | 4.0 | 0.37 | 0.22 | 0.71% | 3.6 | 5.81 | 91.5% | 91.5% |
| | 6.5 | 0.70 | 4.0 | 0.43 | 0.30 | 0.95% | 3.5 | 5.73 | 90.3% | 90.3% |
| | 6.5 | 0.80 | 4.0 | 0.49 | 0.39 | 1.20% | 3.5 | 5.65 | 89.0% | 89.0% |
| | 6.5 | 1.06 | 4.0 | 0.66 | 0.70 | 1.99% | 3.4 | 5.45 | 86.0% | 85.8% |
| 6.0 mm tapes | 6.0 | 0.46 | 4.0 | 0.32 | 0.15 | 0.52% | 3.9 | 5.88 | 92.9% | 92.6% |
| | 6.0 | 0.50 | 4.0 | 0.33 | 0.17 | 0.59% | 3.9 | 5.86 | 92.3% | 92.3% |
| | 6.0 | 0.60 | 4.0 | 0.40 | 0.24 | 0.83% | 3.8 | 5.77 | 90.9% | 90.9% |
| | 6.0 | 0.70 | 4.0 | 0.47 | 0.33 | 1.09% | 3.8 | 5.69 | 89.6% | 89.6% |
| | 6.0 | 0.80 | 4.0 | 0.53 | 0.43 | 1.38% | 3.7 | 5.60 | 88.2% | 88.2% |
| | 6.0 | 0.90 | 4.0 | 0.60 | 0.54 | 1.70% | 3.7 | 5.52 | 87.0% | 87.0% |
| | 6.0 | 0.98 | 4.0 | 0.66 | 0.65 | 1.99% | 3.6 | 5.45 | 86.0% | 85.8% |
| 5.5 mm tapes | 5.5 | 0.42 | 4.0 | 0.32 | 0.13 | 0.52% | 4.3 | 5.88 | 92.9% | 92.6% |
| | 5.5 | 0.50 | 4.0 | 0.36 | 0.18 | 0.69% | 4.2 | 5.82 | 91.7% | 91.7% |
| | 5.5 | 0.60 | 4.0 | 0.44 | 0.26 | 0.97% | 4.2 | 5.73 | 90.2% | 90.2% |
| | 5.5 | 0.70 | 4.0 | 0.51 | 0.36 | 1.27% | 4.1 | 5.63 | 88.7% | 88.7% |
| | 5.5 | 0.80 | 4.0 | 0.58 | 0.47 | 1.61% | 4.0 | 5.54 | 87.3% | 87.3% |
| | 5.5 | 0.90 | 4.0 | 0.66 | 0.59 | 1.99% | 4.0 | 5.45 | 86.0% | 85.8% |
| 5.0 mm tapes | 5.0 | 0.38 | 4.0 | 0.32 | 0.12 | 0.52% | 4.72 | 5.88 | 92.9% | 92.6% |
| | 5.0 | 0.40 | 4.0 | 0.32 | 0.13 | 0.55% | 4.70 | 5.88 | 92.6% | 92.6% |
| | 5.0 | 0.50 | 4.0 | 0.40 | 0.20 | 0.83% | 4.62 | 5.77 | 90.9% | 90.9% |
| | 5.0 | 0.60 | 4.0 | 0.48 | 0.29 | 1.15% | 4.54 | 5.67 | 89.3% | 89.3% |
| | 5.0 | 0.70 | 4.0 | 0.56 | 0.39 | 1.51% | 4.46 | 5.57 | 87.7% | 87.7% |
| | 5.0 | 0.80 | 4.0 | 0.64 | 0.51 | 1.90% | 4.38 | 5.47 | 86.2% | 86.2% |
| | 5.0 | 0.81 | 4.0 | 0.66 | 0.54 | 1.99% | 4.37 | 5.45 | 86.0% | 85.8% |
| 4.5 mm tapes | 4.5 | 0.34 | 4.0 | 0.32 | 0.11 | 0.52% | 5.25 | 5.88 | 92.9% | 92.7% |
| | 4.5 | 0.40 | 4.0 | 0.36 | 0.14 | 0.67% | 5.18 | 5.83 | 91.8% | 91.8% |
| | 4.5 | 0.50 | 4.0 | 0.44 | 0.22 | 1.00% | 5.08 | 5.72 | 90.0% | 90.0% |
| | 4.5 | 0.60 | 4.0 | 0.53 | 0.32 | 1.38% | 4.98 | 5.60 | 88.2% | 88.2% |
| | 4.5 | 0.70 | 4.0 | 0.62 | 0.44 | 1.81% | 4.88 | 5.50 | 86.5% | 86.5% |
| | 4.5 | 0.73 | 4.0 | 0.66 | 0.49 | 1.99% | 4.85 | 5.45 | 86.0% | 85.8% |
| 4.0 mm tapes | 4.0 | 0.30 | 4.0 | 0.32 | 0.10 | 0.52% | 5.90 | 5.89 | 92.9% | 92.7% |
| Open Stage One | 4.0 | 0.35 | 4.0 | 0.35 | 0.12 | 0.65% | 5.84 | 5.84 | 92.0% | 92.0% |
| | 4.0 | 0.40 | 4.0 | 0.40 | 0.16 | 0.83% | 5.77 | 5.77 | 90.9% | 90.9% |
| Open Stage Two | 4.0 | 0.50 | 4.0 | 0.50 | 0.25 | 1.23% | 5.64 | 5.64 | 88.9% | 88.9% |
| | 4.0 | 0.60 | 4.0 | 0.60 | 0.36 | 1.70% | 5.52 | 5.52 | 87.0% | 87.0% |
| Open Stage Three | 4.0 | 0.65 | 4.0 | 0.65 | 0.42 | 1.95% | 5.46 | 5.46 | 86.0% | 86.0% |
| | 4.0 | 0.65 | 4.0 | 0.66 | 0.43 | 1.99% | 5.46 | 5.46 | 86.0% | 85.8% |
| 3.5 mm tapes | 3.5 | 0.27 | 4.0 | 0.31 | 0.08 | 0.51% | 6.75 | 5.89 | 92.9% | 92.7% |
| | 3.5 | 0.30 | 4.0 | 0.34 | 0.10 | 0.62% | 6.68 | 5.85 | 92.1% | 92.1% |
| | 3.5 | 0.40 | 4.0 | 0.46 | 0.18 | 1.05% | 6.51 | 5.70 | 89.7% | 89.7% |
| | 3.5 | 0.50 | 4.0 | 0.57 | 0.29 | 1.56% | 6.35 | 5.56 | 87.5% | 87.5% |
| | 3.5 | 0.57 | 4.0 | 0.66 | 0.38 | 1.99% | 6.24 | 5.45 | 86.0% | 85.8% |
| 3.0 mm tapes | 3.0 | 0.23 | 4.0 | 0.31 | 0.07 | 0.51% | 7.87 | 5.89 | 92.9% | 92.8% |
| | 3.0 | 0.30 | 4.0 | 0.40 | 0.12 | 0.83% | 7.70 | 5.77 | 90.9% | 90.9% |
| | 3.0 | 0.40 | 4.0 | 0.53 | 0.21 | 1.38% | 7.47 | 5.60 | 88.2% | 88.2% |
| | 3.0 | 0.49 | 4.0 | 0.66 | 0.32 | 1.99% | 7.28 | 5.45 | 86.0% | 85.8% |
| 2.5 mm tapes | 2.5 | 0.19 | 4.0 | 0.31 | 0.06 | 0.51% | 9.44 | 5.89 | 92.9% | 92.8% |
| | 2.5 | 0.20 | 4.0 | 0.32 | 0.06 | 0.55% | 9.41 | 5.88 | 92.6% | 92.6% |
| | 2.5 | 0.30 | 4.0 | 0.48 | 0.14 | 1.15% | 9.07 | 5.67 | 89.3% | 89.3% |
| | 2.5 | 0.40 | 4.0 | 0.64 | 0.26 | 1.90% | 8.76 | 5.47 | 86.2% | 86.2% |
| | 2.5 | 0.41 | 4.0 | 0.66 | 0.27 | 1.99% | 8.74 | 5.45 | 86.0% | 85.8% |
| 2.0 mm tapes | 2.0 | 0.15 | 4.0 | 0.31 | 0.05 | 0.50% | 11.80 | 5.90 | 92.9% | 92.9% |
| | 2.0 | 0.20 | 4.0 | 0.40 | 0.08 | 0.83% | 11.55 | 5.77 | 90.9% | 90.9% |
| | 2.0 | 0.30 | 4.0 | 0.60 | 0.18 | 1.70% | 11.04 | 5.52 | 87.0% | 87.0% |
| | 2.0 | 0.33 | 4.0 | 0.66 | 0.22 | 1.99% | 10.92 | 5.45 | 86.0% | 85.8% |

2 to 7 mm Warp/Weft and 4.5 mm Warp/Weft Construction

| | | | | | | | | | | |
|---|---|---|---|---|---|---|---|---|---|---|
| 7.0 mm tapes | 7.0 | 0.53 | 4.5 | 0.34 | 0.18 | 0.50% | 3.4 | 5.2 | 92.9% | 92.9% |
| | 7.0 | 0.60 | 4.5 | 0.39 | 0.23 | 0.62% | 3.3 | 5.2 | 92.1% | 92.1% |
| | 7.0 | 0.70 | 4.5 | 0.45 | 0.32 | 0.83% | 3.3 | 5.1 | 90.9% | 90.9% |
| | 7.0 | 0.80 | 4.5 | 0.51 | 0.41 | 1.05% | 3.3 | 5.1 | 89.7% | 89.7% |
| | 7.0 | 0.90 | 4.5 | 0.58 | 0.52 | 1.30% | 3.2 | 5.0 | 88.6% | 88.6% |
| | 7.0 | 1.14 | 4.5 | 0.75 | 0.85 | 1.99% | 3.1 | 4.8 | 86.0% | 85.8% |
| 6.5 mm tapes | 6.5 | 0.49 | 4.5 | 0.34 | 0.17 | 0.50% | 3.6 | 5.2 | 93.0% | 92.9% |
| | 6.5 | 0.50 | 4.5 | 0.35 | 0.17 | 0.51% | 3.6 | 5.2 | 92.9% | 92.9% |
| | 6.5 | 0.60 | 4.5 | 0.42 | 0.25 | 0.71% | 3.6 | 5.2 | 91.5% | 91.5% |
| | 6.5 | 0.70 | 4.5 | 0.48 | 0.34 | 0.95% | 3.5 | 5.1 | 90.3% | 90.3% |
| | 6.5 | 0.80 | 4.5 | 0.55 | 0.44 | 1.20% | 3.5 | 5.0 | 89.0% | 89.0% |
| | 6.5 | 1.06 | 4.5 | 0.75 | 0.79 | 1.99% | 3.4 | 4.8 | 86.0% | 85.8% |
| 6.0 mm tapes | 6.0 | 0.46 | 4.5 | 0.36 | 0.16 | 0.52% | 3.9 | 5.2 | 92.9% | 92.6% |
| | 6.0 | 0.50 | 4.5 | 0.38 | 0.19 | 0.59% | 3.9 | 5.2 | 92.3% | 92.3% |
| | 6.0 | 0.60 | 4.5 | 0.45 | 0.27 | 0.83% | 3.8 | 5.1 | 90.9% | 90.9% |
| | 6.0 | 0.70 | 4.5 | 0.53 | 0.37 | 1.09% | 3.8 | 5.1 | 89.6% | 89.6% |
| | 6.0 | 0.80 | 4.5 | 0.60 | 0.48 | 1.38% | 3.7 | 5.0 | 88.2% | 88.2% |
| | 6.0 | 0.90 | 4.5 | 0.68 | 0.61 | 1.70% | 3.7 | 4.9 | 87.0% | 88.7% |
| | 6.0 | 0.98 | 4.5 | 0.75 | 0.73 | 1.99% | 3.6 | 4.8 | 86.0% | 85.8% |
| 5.5 mm tapes | 5.5 | 0.42 | 4.5 | 0.36 | 0.15 | 0.52% | 4.3 | 5.2 | 92.9% | 92.6% |
| | 5.5 | 0.50 | 4.5 | 0.41 | 0.20 | 0.69% | 4.2 | 5.2 | 91.7% | 91.7% |
| | 5.5 | 0.60 | 4.5 | 0.49 | 0.29 | 0.97% | 4.2 | 5.1 | 90.2% | 90.2% |
| | 5.5 | 0.70 | 4.5 | 0.57 | 0.40 | 1.27% | 4.1 | 5.0 | 88.7% | 88.7% |
| | 5.5 | 0.80 | 4.5 | 0.65 | 0.52 | 1.61% | 4.0 | 4.9 | 87.3% | 87.3% |
| | 5.5 | 0.90 | 4.5 | 0.75 | 0.67 | 1.99% | 4.0 | 4.8 | 86.0% | 85.8% |
| 5.0 mm tapes | 5.0 | 0.38 | 4.5 | 0.36 | 0.14 | 0.52% | 4.7 | 5.2 | 92.9% | 92.6% |
| | 5.0 | 0.40 | 4.5 | 0.36 | 0.14 | 0.55% | 4.7 | 5.2 | 92.6% | 92.6% |
| | 5.0 | 0.50 | 4.5 | 0.45 | 0.23 | 0.83% | 4.6 | 5.1 | 90.9% | 90.9% |
| | 5.0 | 0.60 | 4.5 | 0.54 | 0.32 | 1.15% | 4.5 | 5.0 | 89.3% | 89.3% |
| | 5.0 | 0.70 | 4.5 | 0.63 | 0.44 | 1.51% | 4.5 | 5.0 | 87.7% | 87.7% |
| | 5.0 | 0.80 | 4.5 | 0.72 | 0.58 | 1.90% | 4.4 | 4.9 | 86.2% | 86.2% |
| | 5.0 | 0.81 | 4.5 | 0.75 | 0.61 | 1.99% | 4.4 | 4.8 | 86.0% | 85.8% |
| 4.5 mm tapes | 4.5 | 0.34 | 4.5 | 0.36 | 0.12 | 0.52% | 5.2 | 5.2 | 92.9% | 92.7% |
| | 4.5 | 0.40 | 4.5 | 0.40 | 0.16 | 0.67% | 5.2 | 5.2 | 91.8% | 91.8% |
| | 4.5 | 0.50 | 4.5 | 0.50 | 0.25 | 1.00% | 5.1 | 5.1 | 90.0% | 90.0% |
| | 4.5 | 0.60 | 4.5 | 0.60 | 0.36 | 1.38% | 5.0 | 5.0 | 88.2% | 88.2% |
| | 4.5 | 0.70 | 4.5 | 0.70 | 0.49 | 1.81% | 4.9 | 4.9 | 86.5% | 86.5% |
| | 4.5 | 0.73 | 4.5 | 0.75 | 0.55 | 1.99% | 4.9 | 4.8 | 86.0% | 85.8% |
| 4.0 mm tapes | 4.0 | 0.30 | 4.5 | 0.36 | 0.11 | 0.52% | 5.9 | 5.2 | 92.9% | 92.7% |
| Open Stage One | 4.0 | 0.35 | 4.5 | 0.39 | 0.14 | 0.65% | 5.8 | 5.2 | 92.0% | 92.0% |
| | 4.0 | 0.40 | 4.5 | 0.45 | 0.18 | 0.83% | 5.8 | 5.1 | 90.9% | 90.9% |
| Open Stage Two | 4.0 | 0.50 | 4.5 | 0.56 | 0.28 | 1.23% | 5.6 | 5.0 | 88.9% | 88.9% |
| | 4.0 | 0.60 | 4.5 | 0.67 | 0.40 | 1.70% | 5.5 | 4.9 | 87.0% | 87.0% |
| Open Stage Three | 4.0 | 0.65 | 4.5 | 0.73 | 0.48 | 1.95% | 5.5 | 4.9 | 86.0% | 86.0% |
| | 4.0 | 0.65 | 4.5 | 0.75 | 0.49 | 1.99% | 5.5 | 4.8 | 86.0% | 85.8% |
| 3.5 mm tapes | 3.5 | 0.27 | 4.5 | 0.35 | 0.09 | 0.51% | 6.7 | 5.2 | 92.9% | 92.7% |
| | 3.5 | 0.30 | 4.5 | 0.39 | 0.12 | 0.62% | 6.7 | 5.2 | 92.1% | 92.1% |
| | 3.5 | 0.40 | 4.5 | 0.51 | 0.21 | 1.05% | 6.5 | 5.1 | 89.7% | 89.7% |
| | 3.5 | 0.50 | 4.5 | 0.64 | 0.32 | 1.56% | 6.4 | 4.9 | 87.5% | 87.5% |
| | 3.5 | 0.57 | 4.5 | 0.75 | 0.43 | 1.99% | 6.2 | 4.8 | 86.0% | 85.8% |
| 3.0 mm tapes | 3.0 | 0.23 | 4.5 | 0.35 | 0.08 | 0.51% | 7.9 | 5.2 | 92.9% | 92.8% |
| | 3.0 | 0.30 | 4.5 | 0.45 | 0.14 | 0.83% | 7.7 | 5.1 | 90.9% | 90.9% |
| | 3.0 | 0.40 | 4.5 | 0.60 | 0.24 | 1.38% | 7.5 | 5.0 | 88.2% | 88.2% |
| | 3.0 | 0.49 | 4.5 | 0.75 | 0.37 | 1.99% | 7.3 | 4.8 | 86.0% | 85.8% |
| 2.5 mm tapes | 2.5 | 0.19 | 4.5 | 0.35 | 0.07 | 0.51% | 9.4 | 5.2 | 92.9% | 92.8% |
| | 2.5 | 0.20 | 4.5 | 0.36 | 0.07 | 0.55% | 9.4 | 5.2 | 92.6% | 92.6% |
| | 2.5 | 0.30 | 4.5 | 0.54 | 0.16 | 1.15% | 9.1 | 5.0 | 89.3% | 89.3% |
| | 2.5 | 0.40 | 4.5 | 0.72 | 0.29 | 1.90% | 8.8 | 4.9 | 86.2% | 86.2% |
| | 2.5 | 0.41 | 4.5 | 0.75 | 0.30 | 1.99% | 8.7 | 4.8 | 86.0% | 85.8% |
| 2.0 mm tapes | 2.0 | 0.15 | 4.5 | 0.34 | 0.05 | 0.50% | 11.8 | 5.2 | 92.9% | 92.9% |
| | 2.0 | 0.20 | 4.5 | 0.45 | 0.09 | 0.83% | 11.5 | 5.1 | 90.9% | 90.9% |
| | 2.0 | 0.30 | 4.5 | 0.67 | 0.20 | 1.70% | 11.0 | 4.9 | 87.0% | 87.0% |
| | 2.0 | 0.33 | 4.5 | 0.75 | 0.24 | 1.99% | 10.9 | 4.8 | 86.0% | 85.8% |

2 to 7 mm Warp/Weft and 5.0 mm Warp/Weft Construction

| | | | | | | | | | | |
|---|---|---|---|---|---|---|---|---|---|---|
| 7.0 mm tapes | 7.0 | 0.53 | 5.0 | 0.38 | 0.20 | 0.50% | 3.4 | 4.7 | 92.9% | 92.9% |
| | 7.0 | 0.60 | 5.0 | 0.43 | 0.26 | 0.62% | 3.3 | 4.7 | 92.1% | 92.1% |
| | 7.0 | 0.70 | 5.0 | 0.50 | 0.35 | 0.83% | 3.3 | 4.6 | 90.9% | 90.9% |
| | 7.0 | 0.80 | 5.0 | 0.57 | 0.46 | 1.05% | 3.3 | 4.6 | 89.7% | 89.7% |
| | 7.0 | 0.90 | 5.0 | 0.64 | 0.58 | 1.30% | 3.2 | 4.5 | 88.6% | 88.6% |
| | 7.0 | 1.14 | 5.0 | 0.83 | 0.95 | 1.99% | 3.1 | 4.4 | 86.0% | 85.8% |
| 6.5 mm tapes | 6.5 | 0.49 | 5.0 | 0.38 | 0.19 | 0.50% | 3.6 | 4.7 | 93.0% | 92.9% |
| | 6.5 | 0.50 | 5.0 | 0.38 | 0.19 | 0.51% | 3.6 | 4.7 | 92.9% | 92.9% |
| | 6.5 | 0.60 | 5.0 | 0.46 | 0.28 | 0.71% | 3.6 | 4.7 | 91.5% | 91.5% |
| | 6.5 | 0.70 | 5.0 | 0.54 | 0.38 | 0.95% | 3.5 | 4.6 | 90.3% | 90.3% |
| | 6.5 | 0.80 | 5.0 | 0.62 | 0.49 | 1.20% | 3.5 | 4.5 | 89.0% | 89.0% |
| | 6.5 | 1.06 | 5.0 | 0.83 | 0.88 | 1.99% | 3.4 | 4.4 | 86.0% | 85.8% |
| 6.0 mm tapes | 6.0 | 0.46 | 5.0 | 0.40 | 0.18 | 0.52% | 3.9 | 4.7 | 92.9% | 92.6% |
| | 6.0 | 0.50 | 5.0 | 0.42 | 0.21 | 0.59% | 3.9 | 4.7 | 92.3% | 92.3% |
| | 6.0 | 0.60 | 5.0 | 0.50 | 0.30 | 0.83% | 3.8 | 4.6 | 90.9% | 90.9% |
| | 6.0 | 0.70 | 5.0 | 0.58 | 0.41 | 1.09% | 3.8 | 4.5 | 89.6% | 89.6% |
| | 6.0 | 0.80 | 5.0 | 0.67 | 0.53 | 1.38% | 3.7 | 4.5 | 88.2% | 88.2% |
| | 6.0 | 0.90 | 5.0 | 0.75 | 0.68 | 1.70% | 3.7 | 4.4 | 87.0% | 87.0% |
| | 6.0 | 0.98 | 5.0 | 0.83 | 0.81 | 1.99% | 3.6 | 4.4 | 86.0% | 85.8% |
| 5.5 mm tapes | 5.5 | 0.42 | 5.0 | 0.40 | 0.17 | 0.52% | 4.3 | 4.7 | 92.9% | 92.6% |
| | 5.5 | 0.50 | 5.0 | 0.45 | 0.23 | 0.69% | 4.2 | 4.7 | 91.7% | 91.7% |
| | 5.5 | 0.60 | 5.0 | 0.55 | 0.33 | 0.97% | 4.2 | 4.6 | 90.2% | 90.2% |
| | 5.5 | 0.70 | 5.0 | 0.64 | 0.45 | 1.27% | 4.1 | 4.5 | 88.7% | 88.7% |
| | 5.5 | 0.80 | 5.0 | 0.73 | 0.58 | 1.61% | 4.0 | 4.4 | 87.3% | 87.3% |
| | 5.5 | 0.90 | 5.0 | 0.83 | 0.74 | 1.99% | 4.0 | 4.4 | 86.0% | 85.8% |
| 5.0 mm tapes | 5.0 | 0.38 | 5.0 | 0.40 | 0.15 | 0.52% | 4.7 | 4.7 | 92.9% | 92.6% |
| | 5.0 | 0.40 | 5.0 | 0.40 | 0.16 | 0.55% | 4.7 | 4.7 | 92.6% | 92.6% |
| | 5.0 | 0.50 | 5.0 | 0.50 | 0.25 | 0.83% | 4.6 | 4.6 | 90.9% | 90.9% |
| | 5.0 | 0.60 | 5.0 | 0.60 | 0.36 | 1.15% | 4.5 | 4.5 | 89.3% | 89.3% |
| | 5.0 | 0.70 | 5.0 | 0.70 | 0.49 | 1.51% | 4.5 | 4.5 | 87.7% | 87.7% |
| | 5.0 | 0.80 | 5.0 | 0.80 | 0.64 | 1.90% | 4.4 | 4.4 | 86.2% | 86.2% |
| | 5.0 | 0.81 | 5.0 | 0.83 | 0.68 | 1.99% | 4.4 | 4.4 | 86.0% | 85.8% |
| 4.5 mm tapes | 4.5 | 0.34 | 5.0 | 0.40 | 0.14 | 0.52% | 5.2 | 4.7 | 92.9% | 92.7% |
| | 4.5 | 0.40 | 5.0 | 0.44 | 0.18 | 0.67% | 5.2 | 4.7 | 91.8% | 91.8% |
| | 4.5 | 0.50 | 5.0 | 0.56 | 0.28 | 1.00% | 5.1 | 4.6 | 90.0% | 90.0% |
| | 4.5 | 0.60 | 5.0 | 0.67 | 0.40 | 1.38% | 5.0 | 4.5 | 88.2% | 88.2% |
| | 4.5 | 0.70 | 5.0 | 0.78 | 0.54 | 1.81% | 4.9 | 4.4 | 86.5% | 86.5% |
| | 4.5 | 0.73 | 5.0 | 0.83 | 0.61 | 1.99% | 4.9 | 4.4 | 86.0% | 85.8% |
| 4.0 mm tapes | 4.0 | 0.30 | 5.0 | 0.39 | 0.12 | 0.52% | 5.9 | 4.7 | 92.9% | 92.7% |
| Open Stage One | 4.0 | 0.35 | 5.0 | 0.44 | 0.15 | 0.65% | 5.8 | 4.7 | 92.0% | 92.0% |
| | 4.0 | 0.40 | 5.0 | 0.50 | 0.20 | 0.83% | 5.8 | 4.6 | 90.9% | 90.9% |
| Open Stage Two | 4.0 | 0.50 | 5.0 | 0.63 | 0.31 | 1.23% | 5.6 | 4.5 | 88.9% | 88.9% |
| | 4.0 | 0.60 | 5.0 | 0.75 | 0.45 | 1.70% | 5.5 | 4.4 | 87.0% | 87.0% |
| Open Stage Three | 4.0 | 0.65 | 5.0 | 0.81 | 0.53 | 1.95% | 5.5 | 4.4 | 86.0% | 86.0% |
| | 4.0 | 0.65 | 5.0 | 0.83 | 0.54 | 1.99% | 5.5 | 4.4 | 86.0% | 85.8% |
| 3.5 mm tapes | 3.5 | 0.27 | 5.0 | 0.39 | 0.10 | 0.51% | 6.7 | 4.7 | 92.9% | 92.7% |
| | 3.5 | 0.30 | 5.0 | 0.43 | 0.13 | 0.62% | 6.7 | 4.7 | 92.1% | 92.1% |
| | 3.5 | 0.40 | 5.0 | 0.57 | 0.23 | 1.05% | 6.5 | 4.6 | 89.7% | 89.7% |
| | 3.5 | 0.50 | 5.0 | 0.71 | 0.36 | 1.56% | 6.4 | 4.4 | 87.5% | 87.5% |
| | 3.5 | 0.57 | 5.0 | 0.83 | 0.47 | 1.99% | 6.2 | 4.4 | 86.0% | 85.8% |
| 3.0 mm tapes | 3.0 | 0.23 | 5.0 | 0.39 | 0.09 | 0.51% | 7.9 | 4.7 | 92.9% | 92.8% |
| | 3.0 | 0.30 | 5.0 | 0.50 | 0.15 | 0.83% | 7.7 | 4.6 | 90.9% | 90.9% |
| | 3.0 | 0.40 | 5.0 | 0.67 | 0.27 | 1.38% | 7.5 | 4.5 | 88.2% | 88.2% |
| | 3.0 | 0.49 | 5.0 | 0.83 | 0.41 | 1.99% | 7.3 | 4.4 | 86.0% | 85.8% |
| 2.5 mm tapes | 2.5 | 0.19 | 5.0 | 0.39 | 0.07 | 0.51% | 9.4 | 4.7 | 92.9% | 92.8% |
| | 2.5 | 0.20 | 5.0 | 0.40 | 0.08 | 0.55% | 9.4 | 4.7 | 92.6% | 92.6% |
| | 2.5 | 0.30 | 5.0 | 0.60 | 0.18 | 1.15% | 9.1 | 4.5 | 89.3% | 89.3% |
| | 2.5 | 0.40 | 5.0 | 0.80 | 0.32 | 1.90% | 8.8 | 4.4 | 86.2% | 86.2% |
| | 2.5 | 0.41 | 5.0 | 0.83 | 0.34 | 1.99% | 8.7 | 4.4 | 86.0% | 85.8% |
| 2.0 mm tapes | 2.0 | 0.15 | 5.0 | 0.38 | 0.06 | 0.50% | 11.8 | 4.7 | 92.9% | 92.9% |
| | 2.0 | 0.20 | 5.0 | 0.50 | 0.10 | 0.83% | 11.5 | 4.6 | 90.9% | 90.9% |
| | 2.0 | 0.30 | 5.0 | 0.75 | 0.23 | 1.70% | 11.0 | 4.4 | 87.0% | 87.0% |
| | 2.0 | 0.33 | 5.0 | 0.83 | 0.27 | 1.99% | 10.9 | 4.4 | 86.0% | 85.8% |

2 to 7 mm Warp/Weft and 5.5 mm Warp/Weft Construction

| | | | | | | | | | | |
|---|---|---|---|---|---|---|---|---|---|---|
| 7.0 mm tapes | 7.0 | 0.53 | 5.5 | 0.42 | 0.22 | 0.50% | 3.4 | 4.3 | 92.9% | 92.9% |
| | 7.0 | 0.60 | 5.5 | 0.47 | 0.28 | 0.62% | 3.3 | 4.3 | 92.1% | 92.1% |
| | 7.0 | 0.70 | 5.5 | 0.55 | 0.39 | 0.83% | 3.3 | 4.2 | 90.9% | 90.9% |
| | 7.0 | 0.80 | 5.5 | 0.63 | 0.50 | 1.05% | 3.3 | 4.1 | 89.7% | 89.7% |
| | 7.0 | 0.90 | 5.5 | 0.71 | 0.64 | 1.30% | 3.2 | 4.1 | 88.6% | 88.6% |
| | 7.0 | 1.14 | 5.5 | 0.91 | 1.04 | 1.99% | 3.1 | 4.0 | 86.0% | 85.8% |
| 6.5 mm tapes | 6.5 | 0.49 | 5.5 | 0.42 | 0.21 | 0.50% | 3.6 | 4.3 | 93.0% | 92.9% |
| | 6.5 | 0.50 | 5.5 | 0.42 | 0.21 | 0.51% | 3.6 | 4.3 | 92.9% | 92.9% |
| | 6.5 | 0.60 | 5.5 | 0.51 | 0.30 | 0.71% | 3.6 | 4.2 | 91.5% | 91.5% |
| | 6.5 | 0.70 | 5.5 | 0.59 | 0.41 | 0.95% | 3.5 | 4.2 | 90.3% | 90.3% |
| | 6.5 | 0.80 | 5.5 | 0.68 | 0.54 | 1.20% | 3.5 | 4.1 | 89.0% | 89.0% |
| | 6.5 | 1.06 | 5.5 | 0.91 | 0.97 | 1.99% | 3.4 | 4.0 | 86.0% | 85.8% |
| 6.0 mm tapes | 6.0 | 0.46 | 5.5 | 0.44 | 0.20 | 0.52% | 3.9 | 4.3 | 92.9% | 92.6% |
| | 6.0 | 0.50 | 5.5 | 0.46 | 0.23 | 0.59% | 3.9 | 4.3 | 92.3% | 92.3% |
| | 6.0 | 0.60 | 5.5 | 0.55 | 0.33 | 0.83% | 3.8 | 4.2 | 90.9% | 90.9% |
| | 6.0 | 0.70 | 5.5 | 0.64 | 0.45 | 1.09% | 3.8 | 4.1 | 89.6% | 89.6% |
| | 6.0 | 0.80 | 5.5 | 0.73 | 0.59 | 1.38% | 3.7 | 4.1 | 88.2% | 88.2% |
| | 6.0 | 0.90 | 5.5 | 0.83 | 0.74 | 1.70% | 3.7 | 4.0 | 87.0% | 87.0% |
| | 6.0 | 0.98 | 5.5 | 0.91 | 0.89 | 1.99% | 3.6 | 4.0 | 86.0% | 85.8% |
| 5.5 mm tapes | 5.5 | 0.42 | 5.5 | 0.44 | 0.18 | 0.52% | 4.3 | 4.3 | 92.9% | 92.6% |
| | 5.5 | 0.50 | 5.5 | 0.50 | 0.25 | 0.69% | 4.2 | 4.2 | 91.7% | 91.7% |
| | 5.5 | 0.60 | 5.5 | 0.60 | 0.36 | 0.97% | 4.2 | 4.2 | 90.2% | 90.2% |
| | 5.5 | 0.70 | 5.5 | 0.70 | 0.49 | 1.27% | 4.1 | 4.1 | 88.7% | 88.7% |
| | 5.5 | 0.80 | 5.5 | 0.80 | 0.64 | 1.61% | 4.0 | 4.0 | 87.3% | 87.3% |
| | 5.5 | 0.90 | 5.5 | 0.91 | 0.82 | 1.99% | 4.0 | 4.0 | 86.0% | 85.8% |
| 5.0 mm tapes | 5.0 | 0.38 | 5.5 | 0.44 | 0.17 | 0.52% | 4.7 | 4.3 | 92.9% | 92.6% |
| | 5.0 | 0.40 | 5.5 | 0.44 | 0.18 | 0.55% | 4.7 | 4.3 | 92.6% | 92.6% |
| | 5.0 | 0.50 | 5.5 | 0.55 | 0.28 | 0.83% | 4.6 | 4.2 | 90.9% | 90.9% |
| | 5.0 | 0.60 | 5.5 | 0.66 | 0.40 | 1.15% | 4.5 | 4.1 | 89.3% | 89.3% |
| | 5.0 | 0.70 | 5.5 | 0.77 | 0.54 | 1.51% | 4.5 | 4.1 | 87.7% | 87.7% |
| | 5.0 | 0.80 | 5.5 | 0.88 | 0.70 | 1.90% | 4.4 | 4.0 | 86.2% | 86.2% |
| | 5.0 | 0.81 | 5.5 | 0.91 | 0.74 | 1.99% | 4.4 | 4.0 | 86.0% | 85.8% |
| 4.5 mm tapes | 4.5 | 0.34 | 5.5 | 0.44 | 0.15 | 0.52% | 5.2 | 4.3 | 92.9% | 92.7% |
| | 4.5 | 0.40 | 5.5 | 0.49 | 0.20 | 0.67% | 5.2 | 4.2 | 91.8% | 91.8% |
| | 4.5 | 0.50 | 5.5 | 0.61 | 0.31 | 1.00% | 5.1 | 4.2 | 90.0% | 90.0% |
| | 4.5 | 0.60 | 5.5 | 0.73 | 0.44 | 1.38% | 5.0 | 4.1 | 88.2% | 88.2% |
| | 4.5 | 0.70 | 5.5 | 0.86 | 0.60 | 1.81% | 4.9 | 4.0 | 86.5% | 86.5% |
| | 4.5 | 0.73 | 5.5 | 0.91 | 0.67 | 1.99% | 4.9 | 4.0 | 86.0% | 85.8% |
| 4.0 mm tapes | 4.0 | 0.30 | 5.5 | 0.43 | 0.13 | 0.52% | 5.9 | 4.3 | 92.9% | 92.7% |
| Open Stage One | 4.0 | 0.35 | 5.5 | 0.48 | 0.17 | 0.65% | 5.8 | 4.2 | 92.0% | 92.0% |
| | 4.0 | 0.40 | 5.5 | 0.55 | 0.22 | 0.83% | 5.8 | 4.2 | 90.9% | 90.9% |
| Open Stage Two | 4.0 | 0.50 | 5.5 | 0.69 | 0.34 | 1.23% | 5.6 | 4.1 | 88.9% | 88.9% |
| | 4.0 | 0.60 | 5.5 | 0.82 | 0.49 | 1.70% | 5.5 | 4.0 | 87.0% | 87.0% |
| Open Stage Three | 4.0 | 0.65 | 5.5 | 0.89 | 0.58 | 1.95% | 5.5 | 4.0 | 86.0% | 86.0% |
| | 4.0 | 0.65 | 5.5 | 0.91 | 0.59 | 1.99% | 5.5 | 4.0 | 86.0% | 85.8% |
| 3.5 mm tapes | 3.5 | 0.27 | 5.5 | 0.43 | 0.11 | 0.51% | 6.7 | 4.3 | 92.9% | 92.7% |
| | 3.5 | 0.30 | 5.5 | 0.47 | 0.14 | 0.62% | 6.7 | 4.3 | 92.1% | 92.1% |
| | 3.5 | 0.40 | 5.5 | 0.63 | 0.25 | 1.05% | 6.5 | 4.1 | 89.7% | 89.7% |
| | 3.5 | 0.50 | 5.5 | 0.79 | 0.39 | 1.56% | 6.4 | 4.0 | 87.5% | 87.5% |
| | 3.5 | 0.57 | 5.5 | 0.91 | 0.52 | 1.99% | 6.2 | 4.0 | 86.0% | 85.8% |
| 3.0 mm tapes | 3.0 | 0.23 | 5.5 | 0.43 | 0.10 | 0.51% | 7.9 | 4.3 | 92.9% | 92.8% |
| | 3.0 | 0.30 | 5.5 | 0.55 | 0.17 | 0.83% | 7.7 | 4.2 | 90.9% | 90.9% |
| | 3.0 | 0.40 | 5.5 | 0.73 | 0.29 | 1.38% | 7.5 | 4.1 | 88.2% | 88.2% |
| | 3.0 | 0.49 | 5.5 | 0.91 | 0.45 | 1.99% | 7.3 | 4.0 | 86.0% | 85.8% |
| 2.5 mm tapes | 2.5 | 0.19 | 5.5 | 0.43 | 0.08 | 0.51% | 9.4 | 4.3 | 92.9% | 92.8% |
| | 2.5 | 0.20 | 5.5 | 0.44 | 0.09 | 0.55% | 9.4 | 4.3 | 92.6% | 92.6% |
| | 2.5 | 0.30 | 5.5 | 0.66 | 0.20 | 1.15% | 9.1 | 4.1 | 89.3% | 89.3% |
| | 2.5 | 0.40 | 5.5 | 0.88 | 0.35 | 1.90% | 8.8 | 4.0 | 86.2% | 86.2% |
| | 2.5 | 0.41 | 5.5 | 0.91 | 0.37 | 1.99% | 8.7 | 4.0 | 86.0% | 85.8% |
| 2.0 mm tapes | 2.0 | 0.15 | 5.5 | 0.42 | 0.06 | 0.50% | 11.8 | 4.3 | 92.9% | 92.9% |
| | 2.0 | 0.20 | 5.5 | 0.55 | 0.11 | 0.83% | 11.5 | 4.2 | 90.9% | 90.9% |
| | 2.0 | 0.30 | 5.5 | 0.82 | 0.25 | 1.70% | 11.0 | 4.0 | 87.0% | 87.0% |
| | 2.0 | 0.33 | 5.5 | 0.91 | 0.30 | 1.99% | 10.9 | 4.0 | 86.0% | 85.8% |

2 to 7 mm Warp/Weft and 6.0 mm Warp/Weft Construction

| | | | | | | | | | | |
|---|---|---|---|---|---|---|---|---|---|---|
| 7.0 mm tapes | 7.0 | 0.53 | 6.0 | 0.46 | 0.24 | 0.50% | 3.4 | 3.9 | 92.9% | 92.9% |
| | 7.0 | 0.60 | 6.0 | 0.51 | 0.31 | 0.62% | 3.3 | 3.9 | 92.1% | 92.1% |
| | 7.0 | 0.70 | 6.0 | 0.60 | 0.42 | 0.83% | 3.3 | 3.8 | 90.9% | 90.9% |
| | 7.0 | 0.80 | 6.0 | 0.69 | 0.55 | 1.05% | 3.3 | 3.8 | 89.7% | 89.7% |
| | 7.0 | 0.90 | 6.0 | 0.77 | 0.69 | 1.30% | 3.2 | 3.8 | 88.6% | 88.6% |
| | 7.0 | 1.14 | 6.0 | 1.00 | 1.14 | 1.99% | 3.1 | 3.6 | 86.0% | 85.8% |
| 6.5 mm tapes | 6.5 | 0.49 | 6.0 | 0.46 | 0.23 | 0.50% | 3.6 | 3.9 | 93.0% | 92.9% |
| | 6.5 | 0.50 | 6.0 | 0.46 | 0.23 | 0.51% | 3.6 | 3.9 | 92.9% | 92.9% |
| | 6.5 | 0.60 | 6.0 | 0.55 | 0.33 | 0.71% | 3.6 | 3.9 | 91.5% | 91.5% |
| | 6.5 | 0.70 | 6.0 | 0.65 | 0.45 | 0.95% | 3.5 | 3.8 | 90.3% | 90.3% |
| | 6.5 | 0.80 | 6.0 | 0.74 | 0.59 | 1.20% | 3.5 | 3.8 | 89.0% | 89.0% |
| | 6.5 | 1.06 | 6.0 | 1.00 | 1.05 | 1.99% | 3.4 | 3.6 | 86.0% | 85.8% |
| 6.0 mm tapes | 6.0 | 0.46 | 6.0 | 0.48 | 0.22 | 0.52% | 3.9 | 3.9 | 92.9% | 92.6% |
| | 6.0 | 0.50 | 6.0 | 0.50 | 0.25 | 0.59% | 3.9 | 3.9 | 92.3% | 92.3% |
| | 6.0 | 0.60 | 6.0 | 0.60 | 0.36 | 0.83% | 3.8 | 3.8 | 90.9% | 90.9% |
| | 6.0 | 0.70 | 6.0 | 0.70 | 0.49 | 1.09% | 3.8 | 3.8 | 89.6% | 89.6% |
| | 6.0 | 0.80 | 6.0 | 0.80 | 0.64 | 1.38% | 3.7 | 3.7 | 88.2% | 88.2% |
| | 6.0 | 0.90 | 6.0 | 0.90 | 0.81 | 1.70% | 3.7 | 3.7 | 87.0% | 87.0% |
| | 6.0 | 0.98 | 6.0 | 1.00 | 0.97 | 1.99% | 3.6 | 3.6 | 86.0% | 85.8% |
| 5.5 mm tapes | 5.5 | 0.42 | 6.0 | 0.48 | 0.20 | 0.52% | 4.3 | 3.9 | 92.9% | 92.6% |
| | 5.5 | 0.50 | 6.0 | 0.55 | 0.27 | 0.69% | 4.2 | 3.9 | 91.7% | 91.7% |
| | 5.5 | 0.60 | 6.0 | 0.65 | 0.39 | 0.97% | 4.2 | 3.8 | 90.2% | 90.2% |
| | 5.5 | 0.70 | 6.0 | 0.76 | 0.53 | 1.27% | 4.1 | 3.8 | 88.7% | 88.7% |
| | 5.5 | 0.80 | 6.0 | 0.87 | 0.70 | 1.61% | 4.0 | 3.7 | 87.3% | 87.3% |
| | 5.5 | 0.90 | 6.0 | 1.00 | 0.89 | 1.99% | 4.0 | 3.6 | 86.0% | 85.8% |
| 5.0 mm tapes | 5.0 | 0.38 | 6.0 | 0.48 | 0.18 | 0.52% | 4.7 | 3.9 | 92.9% | 92.6% |
| | 5.0 | 0.40 | 6.0 | 0.48 | 0.19 | 0.55% | 4.7 | 3.9 | 92.6% | 92.6% |
| | 5.0 | 0.50 | 6.0 | 0.60 | 0.30 | 0.83% | 4.6 | 3.8 | 90.9% | 90.9% |
| | 5.0 | 0.60 | 6.0 | 0.72 | 0.43 | 1.15% | 4.5 | 3.8 | 89.3% | 89.3% |
| | 5.0 | 0.70 | 6.0 | 0.84 | 0.59 | 1.51% | 4.5 | 3.7 | 87.7% | 87.7% |
| | 5.0 | 0.80 | 6.0 | 0.96 | 0.77 | 1.90% | 4.4 | 3.7 | 86.2% | 86.2% |
| | 5.0 | 0.81 | 6.0 | 1.00 | 0.81 | 1.99% | 4.4 | 3.6 | 86.0% | 85.8% |
| 4.5 mm tapes | 4.5 | 0.34 | 6.0 | 0.48 | 0.16 | 0.52% | 5.2 | 3.9 | 92.9% | 92.7% |
| | 4.5 | 0.40 | 6.0 | 0.53 | 0.21 | 0.67% | 5.2 | 3.9 | 91.8% | 91.8% |
| | 4.5 | 0.50 | 6.0 | 0.67 | 0.33 | 1.00% | 5.1 | 3.8 | 90.0% | 90.0% |
| | 4.5 | 0.60 | 6.0 | 0.80 | 0.48 | 1.38% | 5.0 | 3.7 | 88.2% | 88.2% |
| | 4.5 | 0.70 | 6.0 | 0.93 | 0.65 | 1.81% | 4.9 | 3.7 | 86.5% | 86.5% |
| | 4.5 | 0.73 | 6.0 | 1.00 | 0.73 | 1.99% | 4.9 | 3.6 | 86.0% | 85.8% |
| 4.0 mm tapes | 4.0 | 0.30 | 6.0 | 0.47 | 0.14 | 0.52% | 5.9 | 3.9 | 92.9% | 92.7% |
| Open Stage One | 4.0 | 0.35 | 6.0 | 0.52 | 0.18 | 0.65% | 5.8 | 3.9 | 92.0% | 92.0% |
| | 4.0 | 0.40 | 6.0 | 0.60 | 0.24 | 0.83% | 5.8 | 3.8 | 90.9% | 90.9% |
| Open Stage Two | 4.0 | 0.50 | 6.0 | 0.75 | 0.38 | 1.23% | 5.6 | 3.8 | 88.9% | 88.9% |
| | 4.0 | 0.60 | 6.0 | 0.90 | 0.54 | 1.70% | 5.5 | 3.7 | 87.0% | 87.0% |
| Open Stage Three | 4.0 | 0.65 | 6.0 | 0.98 | 0.63 | 1.95% | 5.5 | 3.6 | 86.0% | 86.0% |
| | 4.0 | 0.65 | 6.0 | 1.00 | 0.65 | 1.99% | 5.5 | 3.6 | 86.0% | 85.8% |
| 3.5 mm tapes | 3.5 | 0.27 | 6.0 | 0.47 | 0.13 | 0.51% | 6.7 | 3.9 | 92.9% | 92.7% |
| | 3.5 | 0.30 | 6.0 | 0.51 | 0.15 | 0.62% | 6.7 | 3.9 | 92.1% | 92.1% |
| | 3.5 | 0.40 | 6.0 | 0.69 | 0.27 | 1.05% | 6.5 | 3.8 | 89.7% | 89.7% |
| | 3.5 | 0.50 | 6.0 | 0.86 | 0.43 | 1.56% | 6.4 | 3.7 | 87.5% | 87.5% |
| | 3.5 | 0.57 | 6.0 | 1.00 | 0.57 | 1.99% | 6.2 | 3.6 | 86.0% | 85.8% |
| 3.0 mm tapes | 3.0 | 0.23 | 6.0 | 0.47 | 0.11 | 0.51% | 7.9 | 3.9 | 92.9% | 92.8% |
| | 3.0 | 0.30 | 6.0 | 0.60 | 0.18 | 0.83% | 7.7 | 3.8 | 90.9% | 90.9% |
| | 3.0 | 0.40 | 6.0 | 0.80 | 0.32 | 1.38% | 7.5 | 3.7 | 88.2% | 88.2% |
| | 3.0 | 0.49 | 6.0 | 1.00 | 0.49 | 1.99% | 7.3 | 3.6 | 86.0% | 85.8% |
| 2.5 mm tapes | 2.5 | 0.19 | 6.0 | 0.46 | 0.09 | 0.51% | 9.4 | 3.9 | 92.9% | 92.8% |
| | 2.5 | 0.20 | 6.0 | 0.48 | 0.10 | 0.55% | 9.4 | 3.9 | 92.6% | 92.6% |
| | 2.5 | 0.30 | 6.0 | 0.72 | 0.22 | 1.15% | 9.1 | 3.8 | 89.3% | 89.3% |
| | 2.5 | 0.40 | 6.0 | 0.96 | 0.38 | 1.90% | 8.8 | 3.7 | 86.2% | 86.2% |
| | 2.5 | 0.41 | 6.0 | 1.00 | 0.41 | 1.99% | 8.7 | 3.6 | 86.0% | 85.8% |
| 2.0 mm tapes | 2.0 | 0.15 | 6.0 | 0.46 | 0.07 | 0.50% | 11.8 | 3.9 | 92.9% | 92.9% |
| | 2.0 | 0.20 | 6.0 | 0.60 | 0.12 | 0.83% | 11.5 | 3.8 | 90.9% | 90.9% |
| | 2.0 | 0.30 | 6.0 | 0.90 | 0.27 | 1.70% | 11.0 | 3.7 | 87.0% | 87.0% |
| | 2.0 | 0.33 | 6.0 | 1.00 | 0.32 | 1.99% | 10.9 | 3.6 | 86.0% | 85.8% |

2 to 7 mm Warp/Weft and 6.5 mm Warp/Weft Construction

| | | | | | | | | | | |
|---|---|---|---|---|---|---|---|---|---|---|
| 7.0 mm tapes | 7.0 | 0.53 | 6.5 | 0.50 | 0.26 | 0.50% | 3.4 | 3.6 | 92.9% | 92.9% |
| | 7.0 | 0.60 | 6.5 | 0.56 | 0.33 | 0.62% | 3.3 | 3.6 | 92.1% | 92.1% |
| | 7.0 | 0.70 | 6.5 | 0.65 | 0.46 | 0.83% | 3.3 | 3.6 | 90.9% | 90.9% |
| | 7.0 | 0.80 | 6.5 | 0.74 | 0.59 | 1.05% | 3.3 | 3.5 | 89.7% | 89.7% |
| | 7.0 | 0.90 | 6.5 | 0.85 | 0.76 | 1.31% | 3.2 | 3.5 | 88.6% | 88.5% |
| | 7.0 | 1.14 | 6.5 | 1.08 | 1.23 | 1.99% | 3.1 | 3.4 | 86.0% | 85.8% |
| 6.5 mm tapes | 6.5 | 0.49 | 6.5 | 0.50 | 0.24 | 0.50% | 3.6 | 3.6 | 93.0% | 92.9% |
| | 6.5 | 0.50 | 6.5 | 0.50 | 0.25 | 0.51% | 3.6 | 3.6 | 92.9% | 92.9% |
| | 6.5 | 0.60 | 6.5 | 0.60 | 0.36 | 0.71% | 3.6 | 3.6 | 91.5% | 91.5% |
| | 6.5 | 0.70 | 6.5 | 0.70 | 0.49 | 0.95% | 3.5 | 3.5 | 90.3% | 90.3% |
| | 6.5 | 0.80 | 6.5 | 0.80 | 0.64 | 1.20% | 3.5 | 3.5 | 89.0% | 89.0% |
| | 6.5 | 1.06 | 6.5 | 1.08 | 1.14 | 1.99% | 3.4 | 3.4 | 86.0% | 85.8% |
| 6.0 mm tapes | 6.0 | 0.46 | 6.5 | 0.52 | 0.24 | 0.52% | 3.9 | 3.6 | 92.9% | 92.6% |
| | 6.0 | 0.50 | 6.5 | 0.54 | 0.27 | 0.59% | 3.9 | 3.6 | 92.3% | 92.3% |
| | 6.0 | 0.60 | 6.5 | 0.65 | 0.39 | 0.83% | 3.8 | 3.6 | 90.9% | 90.9% |
| | 6.0 | 0.70 | 6.5 | 0.76 | 0.53 | 1.09% | 3.8 | 3.5 | 89.6% | 89.6% |
| | 6.0 | 0.80 | 6.5 | 0.87 | 0.69 | 1.38% | 3.7 | 3.4 | 88.2% | 88.2% |
| | 6.0 | 0.90 | 6.5 | 0.98 | 0.88 | 1.70% | 3.7 | 3.4 | 87.0% | 87.0% |
| | 6.0 | 0.98 | 6.5 | 1.08 | 1.05 | 1.99% | 3.6 | 3.4 | 86.0% | 85.8% |
| 5.5 mm tapes | 5.5 | 0.42 | 6.5 | 0.52 | 0.22 | 0.52% | 4.3 | 3.6 | 92.9% | 92.6% |
| | 5.5 | 0.50 | 6.5 | 0.59 | 0.30 | 0.69% | 4.2 | 3.6 | 91.7% | 91.7% |
| | 5.5 | 0.60 | 6.5 | 0.71 | 0.43 | 0.97% | 4.2 | 3.5 | 90.2% | 90.2% |
| | 5.5 | 0.70 | 6.5 | 0.83 | 0.58 | 1.27% | 4.1 | 3.5 | 88.7% | 88.7% |
| | 5.5 | 0.80 | 6.5 | 0.95 | 0.76 | 1.61% | 4.0 | 3.4 | 87.3% | 87.3% |
| | 5.5 | 0.90 | 6.5 | 1.08 | 0.97 | 1.99% | 4.0 | 3.4 | 86.0% | 85.8% |
| 5.0 mm tapes | 5.0 | 0.38 | 6.5 | 0.52 | 0.20 | 0.52% | 4.7 | 3.6 | 92.9% | 92.6% |
| | 5.0 | 0.40 | 6.5 | 0.52 | 0.21 | 0.55% | 4.7 | 3.6 | 92.6% | 92.6% |
| | 5.0 | 0.50 | 6.5 | 0.65 | 0.33 | 0.83% | 4.6 | 3.6 | 90.9% | 90.9% |
| | 5.0 | 0.60 | 6.5 | 0.78 | 0.47 | 1.15% | 4.5 | 3.5 | 89.3% | 89.3% |
| | 5.0 | 0.70 | 6.5 | 0.91 | 0.64 | 1.51% | 4.5 | 3.4 | 87.7% | 87.7% |
| | 5.0 | 0.80 | 6.5 | 1.04 | 0.83 | 1.90% | 4.4 | 3.4 | 86.2% | 86.2% |
| | 5.0 | 0.81 | 6.5 | 1.08 | 0.88 | 1.99% | 4.4 | 3.4 | 86.0% | 85.8% |
| 4.5 mm tapes | 4.5 | 0.34 | 6.5 | 0.52 | 0.18 | 0.52% | 5.2 | 3.6 | 92.9% | 92.7% |
| | 4.5 | 0.40 | 6.5 | 0.58 | 0.23 | 0.67% | 5.2 | 3.6 | 91.8% | 91.8% |
| | 4.5 | 0.50 | 6.5 | 0.72 | 0.36 | 1.00% | 5.1 | 3.5 | 90.0% | 90.0% |
| | 4.5 | 0.60 | 6.5 | 0.87 | 0.52 | 1.38% | 5.0 | 3.4 | 88.2% | 88.2% |
| | 4.5 | 0.70 | 6.5 | 1.01 | 0.71 | 1.81% | 4.9 | 3.4 | 86.5% | 86.5% |
| | 4.5 | 0.73 | 6.5 | 1.08 | 0.79 | 1.99% | 4.9 | 3.4 | 86.0% | 85.8% |
| 4.0 mm tapes | 4.0 | 0.30 | 6.5 | 0.51 | 0.16 | 0.52% | 5.9 | 3.6 | 92.9% | 92.7% |
| Open Stage One | 4.0 | 0.35 | 6.5 | 0.57 | 0.20 | 0.65% | 5.8 | 3.6 | 92.0% | 92.0% |
| | 4.0 | 0.40 | 6.5 | 0.65 | 0.26 | 0.83% | 5.8 | 3.6 | 90.9% | 90.9% |
| Open Stage Two | 4.0 | 0.50 | 6.5 | 0.81 | 0.41 | 1.23% | 5.6 | 3.5 | 88.9% | 88.9% |
| | 4.0 | 0.60 | 6.5 | 0.97 | 0.58 | 1.70% | 5.5 | 3.4 | 87.0% | 87.0% |
| Open Stage Three | 4.0 | 0.65 | 6.5 | 1.06 | 0.69 | 1.95% | 5.5 | 3.4 | 86.0% | 86.0% |
| | 4.0 | 0.65 | 6.5 | 1.08 | 0.70 | 1.99% | 5.5 | 3.4 | 86.0% | 85.8% |
| 3.5 mm tapes | 3.5 | 0.27 | 6.5 | 0.51 | 0.14 | 0.51% | 6.7 | 3.6 | 92.9% | 92.7% |
| | 3.5 | 0.30 | 6.5 | 0.56 | 0.17 | 0.62% | 6.7 | 3.6 | 92.1% | 92.1% |
| | 3.5 | 0.40 | 6.5 | 0.74 | 0.30 | 1.05% | 6.5 | 3.5 | 89.7% | 89.7% |
| | 3.5 | 0.50 | 6.5 | 0.93 | 0.46 | 1.56% | 6.4 | 3.4 | 87.5% | 87.5% |
| | 3.5 | 0.57 | 6.5 | 1.08 | 0.62 | 1.99% | 6.2 | 3.4 | 86.0% | 85.8% |
| 3.0 mm tapes | 3.0 | 0.23 | 6.5 | 0.51 | 0.12 | 0.51% | 7.9 | 3.6 | 92.9% | 92.8% |
| | 3.0 | 0.30 | 6.5 | 0.65 | 0.20 | 0.83% | 7.7 | 3.6 | 90.9% | 90.9% |
| | 3.0 | 0.40 | 6.5 | 0.87 | 0.35 | 1.38% | 7.5 | 3.4 | 88.2% | 88.2% |
| | 3.0 | 0.49 | 6.5 | 1.08 | 0.53 | 1.99% | 7.3 | 3.4 | 86.0% | 85.8% |
| 2.5 mm tapes | 2.5 | 0.19 | 6.5 | 0.50 | 0.10 | 0.51% | 9.4 | 3.6 | 92.9% | 92.8% |
| | 2.5 | 0.20 | 6.5 | 0.52 | 0.10 | 0.55% | 9.4 | 3.6 | 92.6% | 92.6% |
| | 2.5 | 0.30 | 6.5 | 0.78 | 0.23 | 1.15% | 9.1 | 3.5 | 89.3% | 89.3% |
| | 2.5 | 0.40 | 6.5 | 1.04 | 0.42 | 1.90% | 8.8 | 3.4 | 86.2% | 86.2% |
| | 2.5 | 0.41 | 6.5 | 1.08 | 0.44 | 1.99% | 8.7 | 3.4 | 86.0% | 85.8% |
| 2.0 mm tapes | 2.0 | 0.15 | 6.5 | 0.50 | 0.08 | 0.50% | 11.8 | 3.6 | 92.9% | 92.9% |
| | 2.0 | 0.20 | 6.5 | 0.65 | 0.13 | 0.83% | 11.5 | 3.6 | 90.9% | 90.9% |
| | 2.0 | 0.30 | 6.5 | 0.97 | 0.29 | 1.70% | 11.0 | 3.4 | 87.0% | 87.0% |
| | 2.0 | 0.33 | 6.5 | 1.08 | 0.35 | 1.99% | 10.9 | 3.4 | 86.0% | 85.8% |

2 to 7 mm Warp/Weft and 7.0 mm Warp/Weft Construction

| | | | | | | | | | | |
|---|---|---|---|---|---|---|---|---|---|---|
| 7.0 mm tapes | 7.0 | 0.53 | 7.0 | 0.53 | 0.28 | 0.50% | 3.4 | 3.4 | 92.9% | 92.9% |
| | 7.0 | 0.60 | 7.0 | 0.60 | 0.36 | 0.62% | 3.3 | 3.3 | 92.1% | 92.1% |
| | 7.0 | 0.70 | 7.0 | 0.70 | 0.49 | 0.83% | 3.3 | 3.3 | 90.9% | 90.9% |
| | 7.0 | 0.80 | 7.0 | 0.80 | 0.64 | 1.05% | 3.3 | 3.3 | 89.7% | 89.7% |
| | 7.0 | 0.90 | 7.0 | 0.90 | 0.81 | 1.30% | 3.2 | 3.2 | 88.6% | 88.6% |
| | 7.0 | 1.14 | 7.0 | 1.16 | 1.32 | 1.99% | 3.1 | 3.1 | 86.0% | 85.8% |
| 6.5 mm tapes | 6.5 | 0.49 | 7.0 | 0.53 | 0.26 | 0.50% | 3.6 | 3.4 | 93.0% | 92.9% |
| | 6.5 | 0.50 | 7.0 | 0.54 | 0.27 | 0.51% | 3.6 | 3.4 | 92.9% | 92.9% |
| | 6.5 | 0.60 | 7.0 | 0.65 | 0.39 | 0.71% | 3.6 | 3.3 | 91.5% | 91.5% |
| | 6.5 | 0.70 | 7.0 | 0.75 | 0.53 | 0.95% | 3.5 | 3.3 | 90.3% | 90.3% |
| | 6.5 | 0.80 | 7.0 | 0.86 | 0.69 | 1.20% | 3.5 | 3.2 | 89.0% | 89.0% |
| | 6.5 | 1.06 | 7.0 | 1.16 | 1.23 | 1.99% | 3.4 | 3.1 | 86.0% | 85.8% |
| 6.0 mm tapes | 6.0 | 0.46 | 7.0 | 0.56 | 0.25 | 0.52% | 3.9 | 3.4 | 92.9% | 92.6% |
| | 6.0 | 0.50 | 7.0 | 0.58 | 0.29 | 0.59% | 3.9 | 3.3 | 92.3% | 92.3% |
| | 6.0 | 0.60 | 7.0 | 0.70 | 0.42 | 0.83% | 3.8 | 3.3 | 90.9% | 90.9% |
| | 6.0 | 0.70 | 7.0 | 0.82 | 0.57 | 1.09% | 3.8 | 3.2 | 89.6% | 89.6% |
| | 6.0 | 0.80 | 7.0 | 0.93 | 0.75 | 1.38% | 3.7 | 3.2 | 88.2% | 88.2% |
| | 6.0 | 0.90 | 7.0 | 1.05 | 0.95 | 1.70% | 3.7 | 3.2 | 87.0% | 87.0% |
| | 6.0 | 0.98 | 7.0 | 1.14 | 1.14 | 1.99% | 3.6 | 3.1 | 86.0% | 85.8% |
| 5.5 mm tapes | 5.5 | 0.42 | 7.0 | 0.56 | 0.23 | 0.52% | 4.3 | 3.4 | 92.9% | 92.6% |
| | 5.5 | 0.50 | 7.0 | 0.64 | 0.32 | 0.69% | 4.2 | 3.3 | 91.7% | 91.7% |
| | 5.5 | 0.60 | 7.0 | 0.76 | 0.46 | 0.97% | 4.2 | 3.3 | 90.2% | 90.2% |
| | 5.5 | 0.70 | 7.0 | 0.89 | 0.62 | 1.27% | 4.1 | 3.2 | 88.7% | 88.7% |
| | 5.5 | 0.80 | 7.0 | 1.02 | 0.81 | 1.61% | 4.0 | 3.2 | 87.3% | 87.3% |
| | 5.5 | 0.90 | 7.0 | 1.16 | 1.04 | 1.99% | 4.0 | 3.1 | 86.0% | 85.8% |
| 5.0 mm tapes | 5.0 | 0.38 | 7.0 | 0.56 | 0.21 | 0.52% | 4.7 | 3.4 | 92.9% | 92.6% |
| | 5.0 | 0.40 | 7.0 | 0.56 | 0.22 | 0.55% | 4.7 | 3.4 | 92.6% | 92.6% |
| | 5.0 | 0.50 | 7.0 | 0.70 | 0.35 | 0.83% | 4.6 | 3.3 | 90.9% | 90.9% |
| | 5.0 | 0.60 | 7.0 | 0.84 | 0.50 | 1.15% | 4.5 | 3.2 | 89.3% | 89.3% |
| | 5.0 | 0.70 | 7.0 | 0.98 | 0.69 | 1.51% | 4.5 | 3.2 | 87.7% | 87.7% |
| | 5.0 | 0.80 | 7.0 | 1.12 | 0.90 | 1.90% | 4.4 | 3.1 | 86.2% | 86.2% |
| | 5.0 | 0.81 | 7.0 | 1.16 | 0.95 | 1.99% | 4.4 | 3.1 | 86.0% | 85.8% |
| 4.5 mm tapes | 4.5 | 0.34 | 7.0 | 0.56 | 0.19 | 0.52% | 5.2 | 3.4 | 92.9% | 92.7% |
| | 4.5 | 0.40 | 7.0 | 0.62 | 0.25 | 0.67% | 5.2 | 3.3 | 91.8% | 91.8% |
| | 4.5 | 0.50 | 7.0 | 0.78 | 0.39 | 1.00% | 5.1 | 3.3 | 90.0% | 90.0% |
| | 4.5 | 0.60 | 7.0 | 0.93 | 0.56 | 1.38% | 5.0 | 3.2 | 88.2% | 88.2% |
| | 4.5 | 0.70 | 7.0 | 1.09 | 0.76 | 1.81% | 4.9 | 3.1 | 86.5% | 86.5% |
| | 4.5 | 0.73 | 7.0 | 1.16 | 0.85 | 1.99% | 4.9 | 3.1 | 86.0% | 85.8% |
| 4.0 mm tapes | 4.0 | 0.30 | 7.0 | 0.55 | 0.17 | 0.52% | 5.9 | 3.4 | 92.9% | 92.7% |
| Open Stage One | 4.0 | 0.35 | 7.0 | 0.61 | 0.21 | 0.65% | 5.8 | 3.3 | 92.0% | 92.0% |
| | 4.0 | 0.40 | 7.0 | 0.70 | 0.28 | 0.83% | 5.8 | 3.3 | 90.9% | 90.9% |
| Open Stage Two | 4.0 | 0.50 | 7.0 | 0.88 | 0.44 | 1.23% | 5.6 | 3.2 | 88.9% | 88.9% |
| | 4.0 | 0.60 | 7.0 | 1.05 | 0.63 | 1.70% | 5.5 | 3.2 | 87.0% | 87.0% |
| Open Stage Three | 4.0 | 0.65 | 7.0 | 1.14 | 0.74 | 1.95% | 5.5 | 3.1 | 86.0% | 86.0% |
| | 4.0 | 0.65 | 7.0 | 1.16 | 0.76 | 1.99% | 5.5 | 3.1 | 86.0% | 85.8% |
| 3.5 mm tapes | 3.5 | 0.27 | 7.0 | 0.55 | 0.15 | 0.51% | 6.7 | 3.4 | 92.9% | 92.7% |
| | 3.5 | 0.30 | 7.0 | 0.60 | 0.18 | 0.62% | 6.7 | 3.3 | 92.1% | 92.1% |
| | 3.5 | 0.40 | 7.0 | 0.80 | 0.32 | 1.05% | 6.5 | 3.3 | 89.7% | 89.7% |
| | 3.5 | 0.50 | 7.0 | 1.00 | 0.50 | 1.56% | 6.4 | 3.2 | 87.5% | 87.5% |
| | 3.5 | 0.57 | 7.0 | 1.16 | 0.66 | 1.99% | 6.2 | 3.1 | 86.0% | 85.8% |
| 3.0 mm tapes | 3.0 | 0.23 | 7.0 | 0.55 | 0.12 | 0.51% | 7.9 | 3.4 | 92.9% | 92.8% |
| | 3.0 | 0.30 | 7.0 | 0.70 | 0.21 | 0.83% | 7.7 | 3.3 | 90.9% | 90.9% |
| | 3.0 | 0.40 | 7.0 | 0.93 | 0.37 | 1.38% | 7.5 | 3.2 | 88.2% | 88.2% |
| | 3.0 | 0.49 | 7.0 | 1.16 | 0.57 | 1.99% | 7.3 | 3.1 | 86.0% | 85.8% |
| 2.5 mm tapes | 2.5 | 0.19 | 7.0 | 0.54 | 0.10 | 0.51% | 9.4 | 3.4 | 92.9% | 92.8% |
| | 2.5 | 0.20 | 7.0 | 0.56 | 0.11 | 0.55% | 9.4 | 3.4 | 92.6% | 92.6% |
| | 2.5 | 0.30 | 7.0 | 0.84 | 0.25 | 1.15% | 9.1 | 3.2 | 89.3% | 89.3% |
| | 2.5 | 0.40 | 7.0 | 1.12 | 0.45 | 1.90% | 8.8 | 3.1 | 86.2% | 86.2% |
| | 2.5 | 0.41 | 7.0 | 1.16 | 0.47 | 1.99% | 8.7 | 3.1 | 86.0% | 85.8% |
| 2.0 mm tapes | 2.0 | 0.15 | 7.0 | 0.53 | 0.08 | 0.50% | 11.8 | 3.4 | 92.9% | 92.9% |
| | 2.0 | 0.20 | 7.0 | 0.70 | 0.14 | 0.83% | 11.5 | 3.3 | 90.9% | 90.9% |
| | 2.0 | 0.30 | 7.0 | 1.05 | 0.32 | 1.70% | 11.0 | 3.2 | 87.0% | 87.0% |
| | 2.0 | 0.33 | 7.0 | 1.16 | 0.38 | 1.99% | 10.9 | 3.1 | 86.0% | 85.8% |

1. A reflective ground cover sheet material woven from warp and weft tapes of a plastics material wherein the average gap between edges of adjacent tapes in both the warp and the weft direction is in the range about 0.1 mm to about 1.2 mm and wherein the material is reflective of at least 50% of visible light (wavelength about 400-700 nm) on at least one side of the material.

2. (canceled)

3. (canceled)

4. (canceled)

5. A reflective ground cover sheet material according to claim 1 wherein the average gap between edges of adjacent tapes in both the warp and the weft direction is in the range about 0.25 mm to about 0.85 mm.

6. A reflective ground cover sheet material according to claim 1 wherein the average gap between edges of adjacent tapes in both the warp and the weft direction is in the range about 0.25 mm to about 0.7 mm.

7. (canceled)

8. A reflective ground cover sheet material according to claim 1 wherein the average gap between edges of adjacent tapes in both the warp and the weft direction is in the range about 0.3 mm to about 0.5 mm.

9. A reflective ground cover sheet material according to claim 1 wherein the area defined between edges of adjacent tapes is in the range about 0.02 to 1.3 mm².

10. A reflective ground cover sheet material according to claim 1 wherein the area defined between edges of adjacent tapes is in the range about 0.05 to 1.0 mm².

11. A reflective ground cover sheet material according to claim 1 wherein the area defined between edges of adjacent tapes is in the range about 0.06 to 0.8 mm².

12. (canceled)

13. (canceled)

14. (canceled)

15. A reflective ground cover sheet material according to claim 1 wherein the material has a porosity in the range about 0.5 to about 2%.

16. (canceled)

17. A reflective ground cover sheet material according to claim 1 wherein the material has a porosity in the range about 0.5 to about 1.7%.

18. A reflective ground cover sheet material according to claim 1 wherein the material has a porosity in the range about 0.5 to about 1.5%.

19. A reflective ground cover sheet material according to claim 1 wherein the material has a porosity in the range from greater than about 0.5% to about 1.3%

20. A reflective ground cover sheet material according to claim 1 wherein the material has a porosity in the range from greater than about 0.5% to about 0.8%.

21. A reflective ground cover sheet material according to claim 1 wherein the material has a porosity in the range from greater than about 1% to about 1.99%.

22. A reflective ground cover sheet material according to claim 1 wherein the material has a warp and weft tape width in the range about 2 to about 7 mm.

23. A reflective ground cover sheet material according to claim 1 wherein the material has a warp and weft tape width in the range from greater than about 3.5 to about 4.5 mm.

24. A reflective ground cover sheet material according to claim 1 wherein the material has a warp and weft tape width in the range from greater than about 3.8 to 4.2 mm.

25. A reflective ground cover sheet material according to claim 1 wherein the material has a warp and weft tape width of about 4 mm.

26. A reflective ground cover sheet material according to claim 1 wherein the material has an insertion/density/number per inch of warp and weft tapes in the range about 3 to about 12 per inch.

27. A reflective ground cover sheet material according to claim 1 wherein the material has an insertion/density/number per inch of warp and weft tapes in the range about 4 to about 10 per inch.

28. A reflective ground cover sheet material according to claim 1 wherein the material has an insertion/density/number per inch of warp and weft tapes in the range about 5 to about 8 per inch.

29. (canceled)

30. A reflective ground cover sheet material according to claim 1 wherein the material has a cover factor in the range of about 75 to about 85%.

31. A reflective ground cover sheet material according to claim 1 wherein the material has a cover factor in the range about 85 to about 95%.

32. (canceled)

33. A reflective ground cover sheet material according to claim 1 wherein the material is reflective of at least 55% of visible light on at least one side of the material.

34. (canceled)

35. A reflective ground cover sheet material according to claim 1 and wherein the material is also reflective of at least 40% solar radiation on average across the UV (wavelength about 280-400 nm) and very near infrared (wavelength about 700-800 nm) ranges, and transmits at least 5% on average of solar radiation across the wavelength range about 800-2500 nm.

36. (canceled)

37. A reflective ground cover sheet material according to claim 1 wherein the material transmits at least 10% of solar radiation on average in the wavelength range about 800-2500 nm.

38. (canceled)

39. (canceled)

40. A ground cover sheet material according to claim 1 wherein some or all of the tapes are formed from a resin comprising a white pigment.

41. (canceled)
